(19) United States
(12) Patent Application Publication
(10) Pub. No.: US 2025/0077043 A1
(43) Pub. Date: Mar. 6, 2025

(54) Methods For Displaying Icons, Electronic Devices And Readable Storage Medium

(71) Applicant: Anhui Huami Health Technology Co., Ltd., Hefei (CN)

(72) Inventors: Sili Zhang, Hefei (CN); Shaoning Wang, Hefei (CN); Yuan Duan, Hefei (CN); Qin Li, Hefei (CN); Yuyan Zhang, Hefei (CN)

(21) Appl. No.: 18/736,176

(22) Filed: Jun. 6, 2024

(30) Foreign Application Priority Data
Aug. 31, 2023 (CN) 202311123595.5

(51) Int. Cl. G06F 3/04817; G06F 3/0482; G06F 3/04845

(52) U.S. Cl. CPC G06F 3/04817; G06F 3/0482; G06F 3/04845; G06F 2203/04806

(57) ABSTRACT

The present disclosure provides a method for icon display, an electronic device, and a readable storage medium. The method includes: displaying a graphical user interface in a first view mode of a plurality of preset view modes, where the graphical user interface includes a plurality of icons, and different preset view modes correspond to different preset icon display sizes; in response to detecting, by the electronic device, a zoom operation of a user, zooming and displaying at least a part of the plurality of icons according to the zoom operation while the zoom operation continues; in response to detecting completion of the zoom operation, determining, by the electronic device, a target view mode from the plurality of preset view modes; and displaying at least a part of the plurality of icons with a preset icon display size corresponding to the target view mode.

### CROSS-REFERENCE TO RELATED APPLICATION(S)

The present application claims priority to Chinese Patent Application No. 202311123595.5, filed Aug. 31, 2023, the entire disclosure of which is hereby incorporated by reference.

### TECHNICAL FIELD

The present disclosure relates to the field of computer software technologies, and in particular, to methods for displaying icons, electronic devices, and computer-readable storage medium.

### BACKGROUND

Icons play an important interactive role in user interfaces. They are widely used in various electronic devices, operating systems and applications. Interacting with users through icons is one of the most widely used interaction methods nowadays.

Icons provide an intuitive way for users to identify and access different functions, applications, or files. For example, on the desktop, each application has a corresponding icon, and the user can click on the icon to launch the corresponding application. Similarly, folders, documents, images, audio/video content and the like can be displayed on the interface with corresponding icons, so that the users can recognize and access them.

### SUMMARY

To overcome at least one of the problems in the related art, the present disclosure provides methods for displaying icons, electronic devices and computer-readable storage mediums.

In a first aspect of the present disclosure, a method for icon display is provided, including:
displaying, by an electronic device, a graphical user interface in a first view mode of a plurality of preset view modes, where the graphical user interface includes a plurality of icons, and different preset view modes in the plurality of preset view modes correspond to different preset icon display sizes;
in response to detecting, by the electronic device, a zoom operation of a user, zooming and displaying at least a part of the plurality of icons according to the zoom operation while the zoom operation is still ongoing;
in response to detecting completion of the zoom operation, determining, by the electronic device, a target view mode from the plurality of preset view modes; and
displaying at least a part of the plurality of icons with a preset icon display size corresponding to the target view mode.

In a second aspect of the present disclosure, another method for icon display is provided, including:
displaying a graphical user interface, where the graphical user interface includes a plurality of icons arranged in columns;
receiving an icon management instruction from a user, where the icon management instruction instructs to change a position of a first icon occupying a first position, and the first position is located in a first column;
removing the first icon from the first position according to the icon management instruction;
determining at least one first shift icon in the first column, where the at least one first shift icon occupies at least one adjacent position in the first column; and
moving each of the at least one first shift icon by one or more positions along a direction toward the first position.

In a third aspect of the present disclosure, an electronic device is provided, including: a processor; and a memory storing executable instructions; where when the processor executes the executable instructions, the method of the first aspect or the second aspect or in any possible implementation thereof is implemented.

In a fourth aspect of the present disclosure, a computer-readable storage medium storing computer programs is provided, where when executed by a processor, the method of the first aspect or the second aspect or in any possible implementation thereof is implemented.

It should be understood that the general description above and the detailed description below are just examples and explanatory, and are not intended to limit the present disclosure.

### BRIEF DESCRIPTION OF THE DRAWINGS

The accompanying drawings herein, which are incorporated into and form a part of the specification, illustrate implementations of the present disclosure and are used in conjunction with the specification to explain the present disclosure.

FIG. 1 is a schematic diagram of a communication system for a wearable device according to some implementations of the present disclosure.

FIG. 2 is a flowchart of a method for icon display according to some implementations of the present disclosure.

FIG. 3 is a schematic diagram of an intermediate view mode or a minimal view mode according to some implementations of the present disclosure.

FIG. 4 is a schematic diagram of the intermediate view mode or the minimal view mode according to some implementations of the present disclosure.

FIG. 5 is a schematic diagram of a maximum view mode according to some implementations of the present disclosure.

FIG. 6 is a schematic diagram illustrating switching among the maximum view mode, the intermediate view mode, and the minimum view mode according to some implementations of the present disclosure.

FIG. 7 is another schematic diagram illustrating switching among the maximum view mode, the intermediate view mode, and the minimum view mode according to some implementations of the present disclosure.

FIG. 8 is a schematic diagram of a graphical user interface displayed in the minimal view mode according to some implementations of the present disclosure.

FIG. 9 is a schematic diagram illustrating a method for calculating a zoom ratio according to some implementations of the present disclosure.

FIG. 10 is another schematic diagram of the method for icon display according to some implementations of the present disclosure.

FIG. 11 is a schematic diagram illustrating moving an icon to a different column according to some implementations of the present disclosure.

FIG. 12 is another schematic diagram illustrating moving an icon to a different column according to some implementations of the present disclosure.

FIG. 13 is a schematic diagram illustrating moving an icon within a column according to some implementations of the present disclosure.

FIG. 14 is a schematic diagram illustrating deletion of an icon according to some implementations of the present disclosure.

FIG. 15 is a schematic diagram of an electronic device according to some implementations of the present disclosure.

### DETAILED DESCRIPTION

Some example implementations will be described in detail herein, with their examples shown in the drawings. When referring to the drawings in the following descriptions, unless otherwise indicated, same reference numbers in different drawings represent the same or similar elements. The implementations described in the following example implementations do not represent all implementations consistent with the present disclosure. Instead, they are examples of devices and methods consistent with some aspects of the present disclosure, as claimed in the attached claims.

The terminology used in the present disclosure is for the purpose of describing specific implementations and is not intended to limit the present disclosure. The terms “a,” “an,” and “the” in the specification and in the attached claims are intended to indicate one or more, unless the context clearly indicates otherwise. It should also be understood that the term A and/or B in the present disclosure refers to at least one of A or B.

It should be understood that, although the terms “first,” “second,” “third,” and the like are used to describe various information and features in the present disclosure, such information and feature is not limited by these terms. These terms are used only to distinguish information or feature of the same type from each other. For example, without departing from the present disclosure, the first information may be the same as or different from the second information, and a particular feature or piece of information can be referred to as a first or a second feature or piece of information. Furthermore, depending on the context, phrases such as “if” as used herein can be interpreted as “when” or “upon” or “in response to”.

Icons play an important interactive role in user interfaces. They are widely used in various electronic devices, operating systems and applications. Interacting with users through icons is one of the most widely used interaction means nowadays. Icons provide an intuitive way for users to identify and access different functions, applications, or files.

To enhance icon display performance, the present disclosure provides a method for icon displaying applicable to an electronic device. The electronic device includes a display supporting multiple preset view modes, where different preset view modes in the multiple preset view modes correspond to different preset icon display sizes. A preset view mode may correspond to one or more preset icon display sizes. For example, the multiple preset view modes include a first view mode and a second view mode. If each of the first view mode and the second view mode corresponds to one preset icon display size, then the preset icon display size corresponding to the first view mode is different from the preset icon display size corresponding to the second view mode. If at least one of the first view mode or the second view mode includes at least two preset icon display sizes, then at least a part of the one or more preset icon display sizes corresponding to the first view mode is different from at least a part of the one or more preset icon display sizes corresponding to the second view mode. For example, the first view mode corresponds to two preset icon display sizes: Size1 and Size2, and the second view mode correspond to one preset icon display size: Size 3, then Size3 is different from at least one of Size1 or Size2.

The electronic device displays a graphical user interface including multiple icons in one of the multiple view modes, and the electronic device may switch from one view mode to another according to user input or according to at least one of the current status of the electronic device, information related to the graphical user interface being displayed, or information related to the current environment.

In some implementations, the multiple preset view modes include a first view mode, and the electronic device displays a graphical interface including multiple icons in the first view mode. The electronic device may detect a zoom operation from a user, and zoom and display at least a part of the plurality of icons included in the graphical user interface according to the zoom operation. Meanwhile, the electronic device continues to detect the zoom operation, and determines whether a completion of the zoom operation is detected. In response to detecting completion of the zoom operation, the electronic device determines a target view mode from the multiple preset view modes based on a zoom ratio or an icon display size instructed at the end of the zoom operation, and displays the graphical user interface in the target view mode, where at least a part of the multiple icons are displayed with the preset icon display size corresponding to the target view mode. This allows users to control icon display on the electronic device in a desired view mode through zoom operations. In some implementations, the electronic device may have a touch-sensitive display, and the user may control the display of the electronic device through making one or more touch gesture on the touch-sensitive display. For example, in response to determining that a user contact on the touch-sensitive display for zoom operation is detected, such as spreading two fingers apart on the touch-sensitive display, the electronic device zooms at least a part of the multiple icons according to a change of the contact position on the display, and detects whether the user contact still exist. If an absent or a break of the user contact is detected, the electronic device selects the target view mode from the multiple preset view modes according to information related to the last moment of the presence of the user contact, such as the last contact position of the user contact, the last display size of the multiple icons before the completion of the user contact, or the like.

On one hand, different users may have varying preferences for icon display sizes. By providing multiple preset view modes corresponding to different preset icon display sizes, users can choose the most suitable icon display sizes based on their preferences and needs, thus achieving personalization and customization of display of the graphical user interface.

On the other hand, some users may have visual impairments or needs for increased visibility and readability of icons. Larger icon display sizes make icons clearer and easier for users to recognize and interact with. Meanwhile, smaller icon display sizes allow for displaying more icons within the limited display area of the electronic device, increasing the information density of the graphical user interface, such as the desktop or application lists, and for users who need to deal with multiple tasks, such preset view modes can enhance efficiency and productivity.

Furthermore, after the zoom operation, the graphical user interface is displayed in one of the multiple preset view modes, providing users with a clear expectation of the icon display effect, and realizing better adapt to their workflow and habits.

To enhance icon display effect, the present disclosure provides another method for icon display. The electronic device displays a graphical user interface including multiple icons, and the plurality of icons are arranged in columns. For example, the graphical user interface includes a plurality of positions arranged in columns, and at least a part of the positions is occupied by the plurality of icons. The electronic device may detect a user input for managing the plurality of icons. In some implementations, an icon management command for managing a position of a first icon is received from a user, where the first icon currently occupies a first position of a first column. The icon management command is used for instructing to delete the first icon from the graphical user interface, move the first icon to another position or the like. In response to the icon management command, the electronic device may change the positions of at least two icons. The at least two icons include the first icon and at least one shift icon adjacent to the first icon in the first column, and optionally further include at least one second shift icon in a second column other than the first column, while keeping the positions of icons in other columns unchanged. At least one first shift icon occupying at least one position adjacent to the first position in the first column is identified, where the at least one first shift icon includes a second icon occupying a position adjacent to the first position. For example, the at least one first shift icon occupies at least one adjacent position from a position adjacent to the first position to a first edge position of the first column, or from a position adjacent to the first position to a second position instructed by the icon management command. The first icon is removed from the first position, and the at least one first shift icon is moved by one or more positions along direction toward the first position. For example, each of the at least one shift icon is moved by one position along a direction toward the first position, such that the second icon is moved to the first position, and the position of the at least one shift icon relative to each other is unchanged. In this way, after the removal of the first icon from the first position, sequential relocation of the at least one first shift icon in the column is realized.

On one hand, this approach maintains visual continuity. By sequentially moving the at least one first shift icon in the first column to fill the gaps, the overall layout of the graphical user interface remains continuous and stable, avoiding abrupt changes or misplacements of the icons, making the user feel more comfortable and natural during interaction with the graphical user interface.

On the other hand, this approach is beneficial for the preservation of user habits and familiarity. Users often develop specific usage habits and memory patterns, becoming accustomed to particular icons appearing in specific positions. By filling the gaps sequentially, and trying to keep the relative positions of the at least one first shift icon in the first column as consistent as possible, users can find and identify the required icons more easily, and do not need to re-adapt or adjust the habit.

The method for icon display provided in the present disclosure may be executed by electronic devices. The electronic device can be a wearable device, including but not limited to, a smartwatch, smart wristband, smart glasses, and the like. The electronic device can also be other types of computing devices, including but not limited to smartphones, tablets, personal digital assistants (PDAs), laptops, desktop computers, and the like.

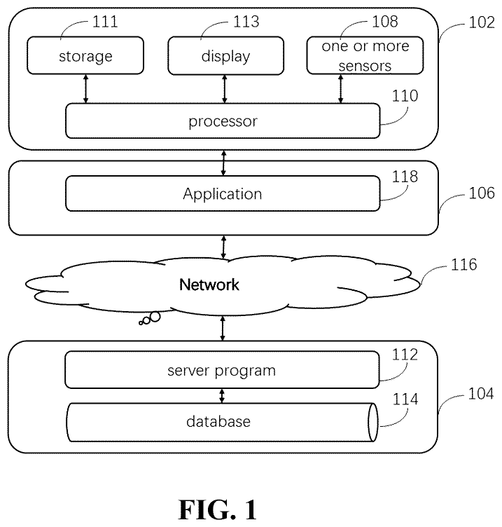

Referring to FIG. 1, FIG. 1 is a schematic diagram of a communication system related to a wearable device. The system includes a wearable device 102, a server 104, and an intermediate device 106.

The wearable device 102 is a computing device configured to be worn by a human user. The wearable device 102 may be implemented as a watch, wristband, bracelet, holder, strap, armband, leg band, ring, headband, headset, glasses, necklace, earpiece, anklet, vest, or the like, or in the form of other wearable devices.

The wearable device 102 includes one or more sensors 108 for detecting physiological parameters of the user wearing the wearable device 102. The sensors 108 may include photoplethysmogram (PPG) sensors, electrocardiogram (ECG) sensors, electrodes, pulse pressure sensors, vascular characteristic sensors, temperature sensors or the like, or a combination of at least two of the above. The physiological parameters represent measurable physiological parameters associated with one or more body systems (e.g., cardiovascular system, respiratory system, autonomic nervous system, temperature system, or other systems) of the user wearing the wearable device 102. For example, the physiological parameters include one or more of the heart rate, heart rate variability, blood oxygen level, blood pressure, temperature, or other physiological parameters of user wearing the wearable device 102. The sensors 108 may collect physiological signal data from the user of the wearable device 102 continuously or otherwise periodically at frequent intervals.

The wearable device 102 also includes a processor 110 and a memory 111. The memory 111 stores application programs or other executable instructions, and the processor 110 is configured to run the application programs or other executable instructions to process physiological signal data generated based on the physiological parameters collected by the sensors 108.

The wearable device 102 also includes a display 113, for displaying a graphical user interface. The display 113 includes, but is not limited to, a liquid crystal display (LCD), an organic light emitting diode display (OLED), a curved display, or a high dynamic range display (HDR), and so on.

The server 104 is a computing device for running a server program 112 to process the physiological signal data. The server 104 can include a hardware server, a software server (e.g., web servers and/or virtual servers), and/or a virtual server.

The server program 112 is a software for detecting one or more of a health condition, exercise condition, sleep condition, or a combination thereof of the user of the wearable device 102 with the physiological signal data. For example, the server program 112 can use the physiological signal data to determine changes in the physiological state of the user and then detect one or more of the health condition, exercise condition, sleep condition, or a combination thereof of the user of the wearable device 102 based on the determined changes.

The server program 112 may access a database 114 on the server 104 to perform at least some of its functions. The database 114 is a database or other type of data storage for storing, managing, or otherwise providing data for the functions of the server program 112. For example, the database 114 stores physiological signal data received by the server 104 and information generated from or otherwise determined based on the physiological signal data. The database 114 may be a relational database management system, an object database, an XML database, a configuration management database, a management information repository, one or more flat files, other suitable non-transitory storage mechanisms, or a combination thereof.

The intermediate device 106 is a device configured to facilitate communications between the wearable device 102 and the server 104. The intermediate device 106 may be a computing device, such as a mobile device (e.g., a smartphone, tablet, laptop, or other type of mobile devices) or other types of computers (e.g., a desktop computer or other non-mobile computers). Alternatively, the intermediate device 106 may be or include a network hardware, such as routers, switches, load balancers, another network device, or a combination thereof. As another alternative, the intermediate device 106 may be other types of network connection device. For example, the intermediate device 106 may be a network connection power charger for the wearable device 102.

For example, in a specific implementation of the intermediate device 106, the intermediate device 106 runs an application 118. The application 118 configures the intermediate device 106 to send data to or receive data from the wearable device 102 and/or send data to or receive data from the server 104. Additionally, the application 118 may respond to commands from the user of the intermediate device 106. For instance, in the case where the intermediate device 106 is a computing device with a touchscreen display, the user of the intermediate device 106 issues commands by touching a portion of the display corresponding to a user interface element in the application.

In some implementations, one or more client devices are granted access to the server program 112. For example, the client devices can be mobile devices such as smartphones, tablets, laptops, and the like. In another example, client devices can be desktop computers or other types of non-mobile computers. The client devices may run client applications to communicate with the server program 112. For instance, the client applications can be mobile apps capable of accessing some or all of the functionality and/or data of the server program 112. In some implementations, the client devices can communicate with the server 104 through the network 116, and in implementations, the client devices can be the intermediate device 106.

In some implementations, the intermediate device 106 receives data from the wearable device 102 with a short-range communication protocol. For example, the short-range communication protocol can be Bluetooth®, Bluetooth® Low Energy, Infrared, Z-Wave, ZigBee, or other protocols, or a combination thereof. The intermediate device 106 then sends the data received from wearable device 102 to server 104 through the network 116. The network 116 can be a local area network, wide area network, machine-to-machine network, virtual private network, or other public or private networks. The network 116 may utilize remote communication protocols, such as Ethernet, TCP, IP, power line communication, Wi-fi, GPRS, GSM, CDMA, or other protocols, or a combination thereof.

In some implementations, the intermediate device 106 can be omitted. For example, the wearable device 102 is configured to communicate directly with the server 104 through network 116. The direct communication between the wearable device 102 and the server 104 via the network 116 may be implemented by remote, low-power systems, or other types of communication mechanism. In some implementations, both the intermediate device 106 and the server 104 can be omitted. For example, the wearable device 102 is configured to perform the functions described above regarding the server 104. In such implementations, the wearable device 102 can independently handle and store data without relying on other computing devices.

In some implementations, the method for icon display provided in the present disclosure can be executed by wearable devices or other types of electronic devices.

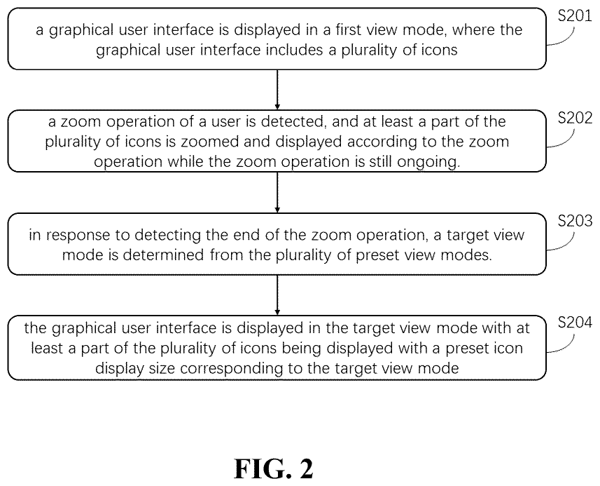

An illustrative description of the method for icon display provided in the present disclosure will be provided below with reference to the flowchart shown in FIG. 2.

At S201, a graphical user interface is displayed in a first view mode, where the graphical user interface includes a plurality of icons.

The electronic device has a plurality of preset view modes, where different preset view modes correspond to different predefined icon display sizes.

In some implementations, in a preset view mode, the plurality of icons are displayed with a same size, and in this case, the predefined icon display size corresponding to this preset view mode is the same size. In other implementations, in a preset view mode, the plurality of icons are displayed with different sizes, and in this case, the predefined icon display size corresponding to this preset view mode is one or more of these different sizes, or the predefined icon display size corresponding to this preset view mode is obtained by processing these different sizes, such as an average result of these different sizes or the like, which is not limited herein.

In some examples, the multiple preset view modes include a maximum view mode, at least one intermediate view mode, and a minimum view mode. The predefined icon display size corresponding to the maximum view mode is the largest among the predefined icon display sizes corresponding to the multiple preset view modes, and the predefined icon display size corresponding to the minimum view mode is the minimum among the predefined icon display sizes corresponding to the multiple preset view modes. The predefined icon display size corresponding to an intermediate view mode falls between the maximum and the minimum values. In the cases where the multiple preset view triodes include at least two intermediate view modes, different intermediate view modes can correspond to different predefined icon display sizes. In some examples, the multiple preset view modes include the maximum view mode and the minimum view mode without any intermediate view mode, which is not limited herein.

The first view mode may be any view mode among the multiple preset view modes, such as the maximum view mode, the minimum view mode, or the intermediate view mode, which is not limited herein.

In some examples, the multiple icons included in the graphical user interface may all be displayed within the display area of the electronic device, namely, the visible area of the display screen. Alternatively, the multiple icons included in the graphical user interface may be partially displayed in the display area of the electronic device, and partially not displayed in the display area of the electronic device. The users may control the graphical user interface to ensure that the content displayed in the graphical user interface meets their current needs.

At S202, a zoom operation of a user is detected, and at least a part of the plurality of icons is zoomed and displayed according to the zoom operation while the zoom operation is still ongoing.

The zoom operation includes, but is not limited to, a contact gesture on the touch-sensitive screen of the electronic device, an operation on an input component such as a button, a crown or the like, or a non-touching gesture performed over the electronic device. In some examples, the electronic device is equipped with or connected with one or more input components, and the zoom operation includes a user operation on an input component. For instance, if the electronic device is a wrist-worn device such as a smartwatch, the input component may be a rotating crown or a button on the smartwatch. For example, the electronic device has at least one button for zoom in and zoom out, such as a zoom-in button and a zoom-out button, or one zoom button for both zoom in and zoom out, and the zoom operation includes a user operation of pressing the at least one button. Alternatively, if the electronic device is a wearable device connected to an input component and the wearable device is connecting to a terminal device with at least one input component, the user may input the command of the zoom operation via the input component of the terminal device. In some other examples, the electronic device includes a touch-sensitive screen, and the zoom operation includes a two-finger pinch or spread gesture performed on the touch-sensitive screen. In some other examples, the display of the electronic device displays one or more control elements for zoom of the icons in the graphical user interface, and the zoom operation includes a user operation on the control element.

At S203, in response to detecting completion of the zoom operation, a target view mode is determined from the plurality of preset view modes.

In response to detecting the triggering of the zoom operation of the user, the electronic device continuously detects completion of the zoom operation. The manner of detecting completion of the zoom operation of the user may depend on the specific implementation of the zoom operation. In some examples, detecting completion of the zoom operation includes detecting completion of the interaction of the user with the input component, such as detecting when the user stops pressing the button, when the user's fingers or user-controlled accessory leaves the button, when the user stops rotating the watch crown, when the user's fingers or user-controlled accessory leaves the watch crown, when the user stop touching the touch-sensitive screen, or when the user's fingers or user-controlled accessory leaves the touch-sensitive screen. In some examples, upon detecting that the user stops rotating the watch crown, it is determined that the zoom operation is completed, otherwise, it is determined that the zoom operation is still ongoing. In some other examples, the electronic device detects when the user's fingers or user-controlled accessory (such as a stylus) stops moving on the touch-sensitive screen, or when the user's fingers or user-controlled accessory leaves the touch-sensitive screen. For instance, upon detecting the user's fingers leaving the touch-sensitive screen, the zoom operation is determined to be over, and otherwise, the zoom operation is determined to be ongoing. In some other examples, the electronic device detects when the user stops touching or interacting with the control element in the graphical user interface. For instance, upon detecting that the user stops sliding a slide control in the graphical user interface, the zoom operation is determined to be completed, and otherwise, the zoom operation is determined to be ongoing.

In some examples, while the user is operating the aforementioned input component, the touchscreen, or the control element, the electronic device may detect the operation instruction of the user in real-time, determine a zoom instruction corresponding to the operation instruction, and respond the operation instruction in real-time. In some examples, if the electronic device does not detect any operation instruction of the user for a continuous period (e.g., within 1 or 2 seconds), it is determined that the zoom operation of the user is completed, thus indicating completion of the zoom operation.

At S204, the graphical user interface is displayed in the target view mode with at least a part of the plurality of icons being displayed with a preset icon display size corresponding to the target view mode.

In the implementations of the present disclosure, the user may customize the electronic device to display the graphical user interface in a desired manner through the zoom operation without the need for precise operation control. This allows for the personalization of the graphical user interface, accommodating different user preferences for icon display sizes. For example, larger icon display sizes can make icons clearer and easier to identify and operate, while smaller icon display sizes can increase information density to meet the needs of users who have to handle multiple tasks simultaneously. Furthermore, after the zoom operation is completed, the icons are displayed in one of the multiple preset view modes, enabling the users to have a clear expectation of the icon display effect.

In some implementations, the first view mode is one of the maximum view mode, the intermediate view mode, or the minimum view mode.

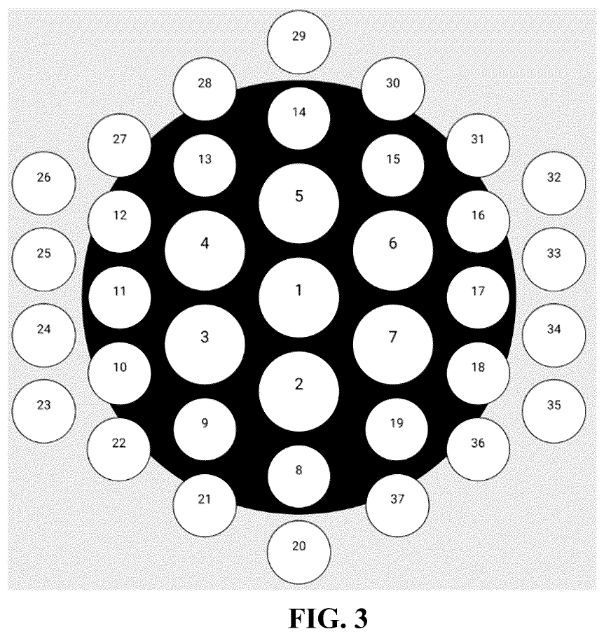

In some examples, in the cases that the graphical user interface is displayed in the intermediate view mode or the minimum view mode, the multiple icons in the graphical user interface are displayed with different sizes. For instance, the multiple icons correspond to a first preset icon display size and a second preset icon display size, where one or more icons in the central area correspond to the first preset icon display size, and one or more icons in the surrounding area correspond the second preset icon display size. The first preset icon display size is larger than the second preset icon display size, and the surrounding icons surround the central icons. FIG. 3 illustrates an example of the intermediate view mode or the minimum view mode. Referring to FIG. 3, the graphical user interface displayed in the intermediate or minimum view mode includes at least two central icons displayed with the first preset icon display size and at least two surrounding icons displayed with the second preset icon display size. The multiple icons in FIG. 3 are arranged in columns, and the icons in adjacent columns are arranged in an alternative pattern, such that the multiple icons are located on multiple hexagons surrounding each other. Additionally, the central icons in FIG. 3 are displayed in the central region of the display area of the electronic device, while the surrounding icons are displayed at the edge region of the display area of the electronic device, making the central icons to be seen more clearly by users.

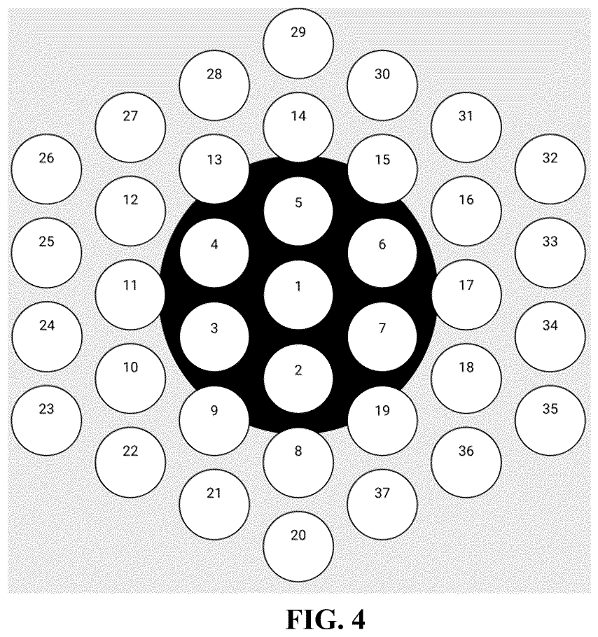

In some other examples, in the cases where the graphical user interface is displayed in the intermediate view mode or the minimum view mode, the multiple icons are displayed with a same size, and at least two of the multiple icons are displayed in the display area of the electronic device. FIG. 4 illustrates another example of the intermediate or the minimum view mode. Referring to FIG. 4, in the intermediate or minimum view mode, the graphical user interface displayed includes at least two icons displayed with a third preset icon display size, where the at least two icons are arranged in columns and located on one or more hexagons surrounding each other.

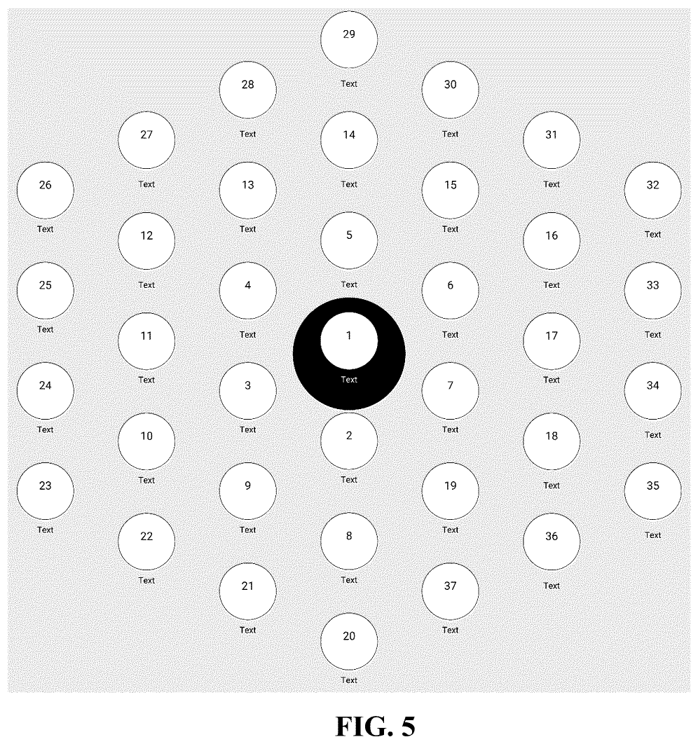

In some examples, in the cases that the graphical user interface is displayed in the maximum view mode, the multiple icons are displayed with a same size, and only one of the icons is in the display area of the electronic device and can be seen by users. FIG. 5 illustrates an example of the maximum view mode. Referring to FIG. 5, in the maximum view mode, the graphical user interface displayed by the electronic device includes a center icon (such as icon 1 in FIG. 5) located in a first position and having a fourth preset icon display size, as well as icon description text (such as “Text” below the icon 1 in FIG. 5) located in a second position near to the first position. The first position may be in the central region of the display area. The fourth preset icon display size may be larger than at least one of the first preset icon display size or the third preset icon display size. The center icon may be an icon that overlaps with the display area of the screen the most among the multiple icons, or an icon occupying the central position of the graphical user interface, but it is not limited herein. The black area in FIG. 5 represents the display area of the electronic device, and it can be seen that, in the maximum view mode, the display area of the electronic device shows only one icon along with the text description of the icon. This allows users to understand relevant information about the icon through the text description, and a relatively large icon display size makes the icon clearer and easier to be recognized and interacted with.

In the examples shown in FIGS. 3 to 5, the plurality of icons are arranged in columns, and the icons locate on multiple surrounding hexagons. In some other examples, the plurality of icons may also be arranged in other shapes, such as circles, rectangles, or the like, which is not limited herein.

The graphical user interface includes a plurality of icon positions, and numbering of the icon positions or numbering of the multiple icons occupying different icon positions is illustrated below. In the graphical user interface, the plurality of icon positions are arranged in rings, centered and aligned by column. The icon positions in adjacent columns are located on a plurality of rings, which can be circular, hexagonal, rectangular, and so forth. In some examples, an icon position at the center of the circle is labeled as position 1, and starting from the center icon position, the numbering of icon positions increases gradually according to a specific rule. In some examples, the numbering of the icon positions increases gradually along the clockwise direction of the spiral. For instance, in the examples shown in FIGS. 3 to 5, the icon position directly below position 1 is labeled as position 2, and the plurality of icon positions on the first hexagon increase gradually along the clockwise direction. The icon position below position 1 on the second hexagon is labeled as position 8, and the plurality of icon positions on the second hexagon increase gradually along the clockwise direction, and so on. In some other examples, the starting position of the hexagon may be directly above and adjacent to position 1 or be other position. In some other examples, numbering of the icon positions is increased along the counterclockwise direction with the center icon position as the starting point. In some other examples, the plurality of icon positions may start from the top or bottom icon position, or start from the center or edge position in the center or edge column, which is not limited herein.

In some examples, it is assumed that the electronic device has a circular display area, which is represented by the black area in the accompany drawings. In other examples, the electronic device may have a display area with other shapes, such as a rectangle, a hexagon, an ellipse or the like. The plurality of icons included in the graphical user interface may be all in the display area of the electronic device. Alternatively, a part of the icons included in the graphical user interface is currently located within the display area and is visible to the user, while the other part of icons is currently located outside the display area and is invisible to the user. It should be understood that, in the implementations of the present application, the term “displayed graphical user interface”, “displayed icons” or the like refers to the portion of the graphical user interface that is located within the display area of the electronic device, i.e., the portion of the graphical user interface that is visible for the user.

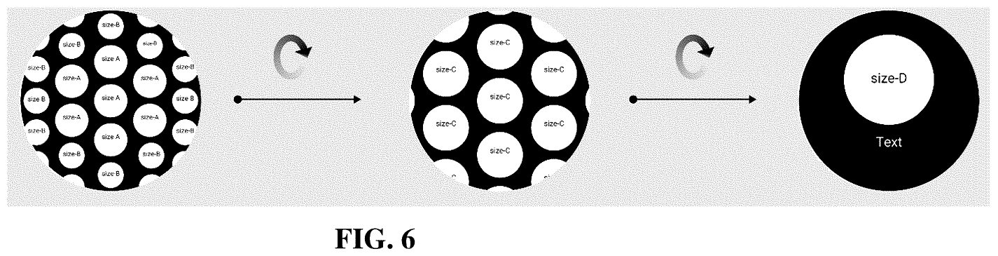

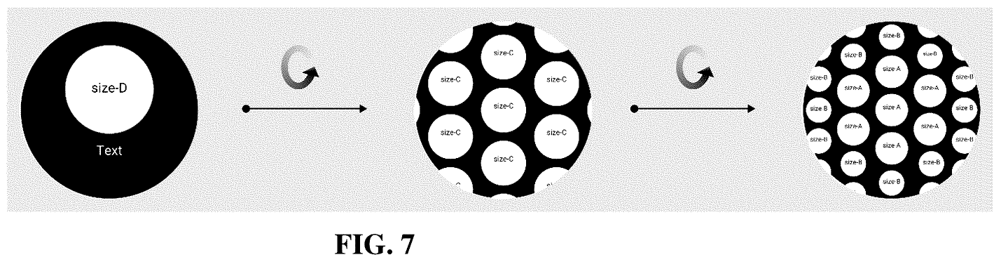

In the implementations of the present application, the user may switch the display of the graphical user interface among the plurality of preset view modes through the zoom operation. In response to the detection of completion of the zoom operation, the electronic device may determine the target view mode from the plurality of preset view modes, and display the graphical user interface in the target view mode. In this case, after the zoom operation is completed, the display mode of the graphical user interface is always one of the plurality of preset view modes, which can reduce the difficulty of user operation. In some cases, the target view mode may be the same as the first view mode, and in this case, the view modes before and after the zoom operation are the same. Alternatively, the target view mode may be a second view mode different from the first view mode. Taking the zoom operation being achieved by rotation of a watch crown as an example, clockwise rotation of the crown is a zoom-in operation, and counterclockwise rotation is a zoom-out operation. Referring to the example shown in FIG. 6, the user may rotate the crown clockwise to switch the display mode of the graphical user interface from the minimum view mode to the intermediate view mode, and then from the intermediate view mode to the maximum view mode. Referring to the example shown in FIG. 7, the user can rotate the crown counterclockwise to switch the display mode of the graphical user interface from the maximum view mode to the intermediate view mode, and then from the intermediate view mode to the minimum view mode. In the examples shown in FIGS. 6 and 7, in the minimum view mode, the plurality of icons are displayed with a first preset icon display size (e.g., Size A) and a second preset icon display size (e.g., Size B). The displayed graphical user interface, i.e., the part in the display area of the electronic device, includes multiple circular arranged icons, and a plurality of icons in the central area are displayed with the first preset icon display size, while the rest of the icons surrounding the central area are displayed with the second preset icon display size. In the intermediate view mode, the displayed graphical user interface includes a plurality of icons arranged on a circle, and the plurality of icons are displayed with a third preset icon display size (e.g., Size C) larger than the first preset icon display size. In the maximum view mode, the displayed graphical user interface includes one icon and corresponding text description, and the icon is displayed with a fourth preset icon display size (e.g., Size D) larger than the third preset icon display size. In some other examples, at least one of the maximum view mode, the intermediate view mode, and the minimum view mode may be implemented with other configurations. For example, the arrangement of the plurality of icons in the graphical user interface, or the display size of the plurality of icons, which is not limited herein. In some other examples, the user may control the display mode of the graphical user interface to switch in any desired pattern, such as firstly from the maximum view mode to the intermediate view mode, and then from the intermediate view mode to the maximum view mode, or the like, which is not limited herein.

The electronic device may determine the target view mode from the multiple preset view modes in various manners. In some implementations, the electronic device may determine the target view mode based on at least one selected from a group including the first view mode, a current zoom instruction, a current view mode at the end of the zoom operation, current display sizes of the icons at the end of the zoom operation, preset icon display sizes corresponding to the plurality of preset view mode, or the like. The current view mode or the current display sizes of the icons at the end of the zoom operation can include, for example, the current view mode or the current display sizes of the icons just before the completion of the zoom operation while the user is still touching the screen, or the current view mode or the current display sizes of the icons in the last time it is detected that the user is touching the screen, or the current view mode or the current display sizes of the icons just before the user's fingers or the like leaving or stopping touching the screen, which is not limited in the present disclosure.

In some implementations, the electronic device can determine the target view mode based on the current state of the graphical user interface at the end of the zoom operation. The display mode of the graphical user interface at the end of the zoom operation may be still the first view mode. Alternatively, the display mode of the graphical user interface at the end of the zoom operation may be a view mode different than the first view mode. In some examples, the electronic device may determine a current view mode for displaying the graphical user interface at the end of the zoom operation, and determine the current view mode as the target view mode. In some other examples, the electronic device may determine the current view mode for displaying the graphical user interface as well as current display sizes of the icons at the end of the zoom operation, and determine the target view mode from the current view mode and at least one adjacent preset view mode based on the current display sizes of the icons at the end of the zoom operation, where adjacent preset view modes correspond to preset icon display sizes adjacent to each other in a set of preset icon display sizes corresponding to the plurality of preset view modes. For instance, the electronic device may compare the current display sizes of the icons with the preset icon display size corresponding to the current view mode, and/or compare the current display sizes of the icons with the preset icon display size corresponding to at least one adjacent view mode, and determine the target view mode based on the comparison results. In some other examples, the electronic device may determine the current display sizes of the icons at the end of the zoom operation, and determine the target view mode based on the current display sizes of the icons.

In some implementations, as the zoom operation continues, it is possible that the zoom operation lasts for a period of time and changes dynamically over time. In this case, a zoom instruction corresponding to the zoom operation, such as the display sizes of icons and zoom ratio instructed by the zoom operation, change over time. The electronic device may determine a current zoom instruction at the end of the zoom operation, such as the zoom ratio or icon display size instructed at the end of the zoom operation, and determine the target view mode from the multiple preset view modes based on the zoom ratio or icon display size instructed at the end of the zoom operation. As discussed above, the current view mode, the current display sizes of the icons, or the current zoom instruction (such as the zoom ratio or icon display size) at the end of the zoom operation can include, for example, the current view mode, the current display sizes of the icons, or the current zoom instruction (such as the zoom ratio or icon display size) just before the completion of the zoom operation while the user is still touching the screen, or just before the user's fingers or the like leaving or stopping touching the screen.

In some examples, the zoom ratio or icon display size instructed at the end of the zoom operation may be determined based on the operation state of the user at the end of the zoom operation, the state of the graphical user interface at the end of the zoom operation, or the like. For example, the zoom ratio or icon display size instructed at the end of the zoom operation is determined based on an amount of rotation of the crown. For another example, the zoom ratio or icon display size instructed at the end of the zoom operation is determined based on a distance between two fingers of the user, or a distance at least one finger slides on the touch-sensitive screen of the electronic device. For another example, the zoom ratio or icon display size instructed at the end of the zoom operation is determined based on the amount or duration of manipulation by the user on a control element of the graphical user interface, such as a distance between the current position and the original position of a slide component.

In some other examples, the zoom ratio or icon display size instructed at the end of the zoom operation is determined based on the state of the graphical user interface at the end of the zoom operation, such as the display size of at least one displayed icon, a current display mode of the graphical user interface, or the like. For instance, the icon display size instructed at the end of the zoom operation is determined according to the display size of at least one icon in the graphical user interface at the end of the zoom operation. For another instance, the zoom ratio instructed at the end of the zoom operation is determined according to a difference between the display size of at least one icon at the end of the zoom operation and the initial display size of the at least one icon.

In some implementations, the electronic device may determine the target view mode according to the zoom ratio or icon display size at the end of the zoom operation and a preset threshold. Taking the first view mode being the minimum view mode as an example, if the zoom ratio instructed at the end of the zoom operation being greater than or equal to a preset threshold, the intermediate view mode is determined as the target view mode. If the zoom ratio instructed at the end of the zoom operation being less than the preset threshold, the minimum view mode is determined as the target view mode.

In some other implementations, the electronic device may determine a zoom ratio or preset icon display size corresponding to each of the plurality of preset view modes, and determine the target view mode based on the zoom ratio or icon display size instructed at the end of the zoom operation, as well as the zoom ratio or preset icon display size corresponding to each of the plurality of preset view modes. For example, the electronic device may compare the zoom ratio or icon display size instructed at the end of the zoom instruction with that corresponding to one or more preset view modes, and determine the target view mode based on the comparison result. As discussed above, the current view mode, the current display sizes of the icons, the current zoom instruction (such as the zoom ratio or icon display size), the state of the graphical user interface or the like at the end of the zoom operation can include, for example, the current view mode, the current display sizes of the icons, the current zoom instruction (such as the zoom ratio or icon display size), the state of the graphical user interface or the like just before the completion of the zoom operation while the user is still touching the screen, or just before the user's fingers or the like leaving or stopping touching the screen.

In the present disclosure, a zoom ratio corresponding to a preset view mode may be determined in various manners. For instance, a zoom ratio corresponding to a preset view mode may be preset. Alternatively, a zoom ratio corresponding to a preset view mode may depend on the first view mode and the preset view mode. In some examples, the zoom ratio corresponding to a preset view mode may depend on a difference between a preset icon display size corresponding to the preset view mode and a preset icon display size corresponding to the first view mode. For instance, the zoom ratio corresponding to a preset view mode is a ratio between the preset icon display size corresponding to the preset view mode and the preset icon display size corresponding to the first view mode. In some other examples, the zoom ratio corresponding to a preset view mode is determined based on an interval between the preset icon display size corresponding to the preset view mode and the preset icon display size corresponding to the first view mode among the multiple preset icon display sizes. For instance, the first view mode is an intermediate view mode, and a zoom ratio corresponding to the minimum view mode or the maximum view mode is determined based on a difference between the preset icon display size corresponding to the minimum view mode or the maximum view mode and the preset icon display size corresponding to the intermediate view mode. For another instance, if there is zero, one or more preset icon display sizes between the preset icon display size corresponding to a preset view mode and the preset icon display size corresponding to the first view mode, the zoom ratio corresponding to the preset view mode is determined based on a correspondence between the numbers of preset icon display sizes between the preset icon display sizes corresponding to the preset view mode and the first view mode. In some other examples, the zoom ratio corresponding to each preset view mode is preset for the first view mode. In some examples, during the zoom operation of the user, the display mode of the graphical user interface may be switched in real-time based on the current zoom instruction of the zoom operation. In this case, the zoom ratio corresponding to a preset view mode may depend on a current view mode at the end of the zoom operation and the preset view mode. For example, the zoom ratio corresponding to a preset view mode may depend on a difference between a preset icon display size corresponding to the current view mode at the end of the zoom operation and a preset icon display size corresponding to the preset view mode. For another example, the zoom ratio corresponding to a preset view mode is preset for a particular current view mode at the end of the zoom operation. The zoom ratio corresponding to a preset view mode can be determined in other ways, and no specific limitation is provided herein.

In some implementations, through a zoom operation, the user is able to switch the display mode of the graphical user interface from the first view mode only to an adjacent view mode corresponding to a preset icon display size adjacent to that corresponding to the first view. In this case, the target view mode is selected from the first view mode and the adjacent view mode, such as a second view mode. The electronic device may compare the zoom ratio or icon display size instructed at the end of the zoom instruction with the zoom ratio or preset icon display size corresponding to the second view mode, and determine the first or second view mode as the target view mode according to the comparison result. For instance, if the first view mode is the minimum view mode, and the zoom ratio or icon display size instructed at the end of the zoom operation is greater than or equal to a zoom ratio or preset icon display size corresponding to the intermediate view mode, then the intermediate view mode is determined as the target view mode. For another instance, if the zoom ratio or icon display size instructed at the end of the zoom operation is less than the zoom ratio or preset icon display size corresponding to the intermediate view mode, the minimum view mode is determined as the target view mode.

In some other implementations, the user can switch the display mode of the graphical user interface to any preset display mode through a zoom operation, and the target view mode may correspond to a preset icon display size adjacent or non-adjacent to the preset icon display size corresponding to the first view mode. In this case, the electronic device may compare the zoom ratio or icon display size instructed at the end of the zoom instruction with the zoom ratio or preset icon display size corresponding to each preset view mode.

In some examples, a preset view mode, which corresponds to a zoom ratio or preset icon display size closest to the zoom ratio or icon display size instructed at the end of the zoom instruction, is determined as the target view mode. For instance, if a difference between the zoom ratio or icon display size instructed at the end of the zoom operation and a zoom ratio or preset icon display size corresponding to a second view mode is greater than that for a third view mode, then the second view mode is determined as the target view mode.

In some other examples, a preset view mode, which corresponds to a zoom ratio or preset icon display size having a difference with the zoom ratio or icon display size instructed at the end of the zoom instruction within a certain range or lower than a preset difference threshold, is determined as the target view mode. For instance, if a difference between a zoom ratio or preset icon display size corresponding to a second view mode and the zoom ratio or icon display size instructed at the end of the zoom instruction is within a first range, the second view mode is determined as the target view mode. For another instance, if a difference between the zoom ratio or icon display size instructed at the end of the zoom operation and a zoom ratio or preset icon display size corresponding to the first view mode is within a second range, the first view mode is determined as the target view mode. The first and second ranges can be set according to specific requirements, which is not limited herein.

In some other examples, responsive to the zoom ratio or icon display size instructed at the end of the zoom operation reaching a zoom ratio or a preset icon display size corresponding to a preset view mode, the electronic device may determine the preset view mode as the target view mode. In some other examples, the zoom ratio or icon display size instructed at the end of the zoom operation reaches a zoom ratio or preset icon display size corresponding to each of at least two other preset view modes, the electronic device may determine a preset view mode, which corresponds to a largest zoom ratio for a zoom-in operation or a smallest zoom ratio for a zoom-out operation, or corresponds to a preset icon display size having a largest difference with that corresponding to the first view mode, as the target view mode. In some other examples, responsive to the zoom ratio or icon display size instructed at the end of the zoom operation not reaching a zoom ratio or a preset icon display size corresponding to any other preset view mode, the first view mode is determined as the target view mode.

Taking the first view mode being the minimum view mode as an example, for instance, if the first view mode is the minimum view mode, and the zoom ratio or icon display size instructed at the end of the zoom operation is greater than or equal to a zoom ratio or a preset icon display size corresponding to the intermediate view mode, but less than a zoom ratio or a preset icon display size corresponding to the maximum view mode, then the intermediate view mode is determined as the target view mode. For another instance, if the zoom ratio or icon display size instructed at the end of the zoom operation is greater than or equal to the zoom ratio or icon display size corresponding to the maximum view mode, then the maximum view mode is determined as the target view mode. For another instance, if the zoom ratio or icon display size instructed at the end of the zoom operation is less than the zoom ratio or icon display size corresponding to the intermediate view mode, then the minimum view mode is determined as the target view mode.

In some implementations, during the zoom operation of the user, the electronic device zooms and displays the icons in real-time based on the current instruction of the zoom operation, and the icons may be displayed with a size different from a preset icon display size corresponding to the first view mode. If the zoom ratio or icon display size currently instructed by the zoom operation matches with another preset view mode, the display mode of the graphical user interface may be switched to the another display mode. In this case, at the end of the zoom operation, the graphical user interface may be displayed in a view mode other than the first view mode, or the graphical user interface may be displayed in the first view mode, with the display size of the icons different from the preset icon display size corresponding to the first view mode. The electronic device may determine the target view mode according to the zoom ratio or icon display size instructed at the end of the zoom operation and a current view mode at the end of the zoom operation.

In some examples, if the current view mode at the end of the zoom operation is the maximum view mode, and the zoom ratio or icon display size instructed at the end of the zoom operation is greater than a zoom ratio or preset icon display size corresponding to the maximum view mode, then the maximum view mode is determined as the target view mode. While the zoom operation continues, the icons can be further enlarged on the basis of the preset icon display size corresponding to the maximum view mode, and after the zoom operation is completed, the icons are restored to the preset icon display size corresponding to the maximum view mode, providing certainty and predictability in the display of the graphical user interface, and the user can continue to operate in the familiar maximum view mode.

In some other examples, if the current view mode at the end of the zoom operation is the maximum view mode, and the zoom ratio or the icon display size instructed at the end of the zoom operation being smaller than zoom ratio or the preset icon display size corresponding to the maximum view mode, then the intermediate view mode is determined as the target view mode, or the target view mode is selected between the maximum view mode and the intermediate view mode based on the zoom ratio or icon display size instructed at the end of the zoom operation based on other criteria. Please refer to the description above for specific details, which will not be reiterated herein.

In some other examples, if the current view mode at the end of the zoom operation is the minimum view mode, and the zoom ratio or icon display size instructed at the end of the zoom operation is smaller than the preset icon display size corresponding to the minimum view mode, then the minimum view mode is determined as the target view mode. While the zoom operation continues, the icons can be further reduced on the basis of the preset icon display size corresponding to the minimum view mode, and after the zoom operation is completed, the icons are restored to the preset icon display size corresponding to the minimum view mode, providing certainty and predictability in the display of the graphical user interface, and the user can continue to operate in the familiar minimum view mode.

In some other examples, if the current view mode at the end of the zoom operation is the minimum view mode, and the zoom ratio or icon display size instructed at the end of the zoom operation being greater than the zoom ratio or preset icon display size corresponding to the minimum view mode, then the intermediate view mode is determined as the target view mode, or the target view mode is selected between the minimum view mode and the intermediate view mode based on other criteria. Please refer to the description above for specific details, which will not be reiterated herein.

In the implementations of the present application, after the zoom operation of the user is completed, the graphical user interface is displayed in one of the multiple preset view modes, providing certainty and predictability in the display of the graphical user interface, avoiding uncertainty for the user caused by the transitional states between the preset view modes at the end of the zoom operation, and facilitating simplification of the user's operation. Users typically wish to adjust the displayed graphical user interface to a desired view mode during a zoom operation, and maintain the state after releasing the input, so as to carry out a subsequent operation or task. With the above approach, instead of requiring the user to precisely zoom to the zoom ratio corresponding to the target view mode, the electronic device determines which view mode is closer to the operation instruction at the end of the zoom operation and determines a corresponding target view mode, thus avoiding or reducing the need for the user to fine-tune the zoom ratio for several times to reach the zoom ratio corresponding to the target view mode, and making it more convenient for the operations of the users.

In some implementations, the graphical user interface may be kept in the first view mode throughout the zoom operation, until the zoom operation is completed. In this case, during the continuous zoom operation of the user on the electronic device, such as the user continuously rotating the crown, or two fingers of the user gradually spreading apart or pinching together on the touchscreen, the electronic device may scale the plurality of icons and display at least one icon in the graphical user interface based on the zoom ratio or icon display size currently instructed by the zoom operation, i.e., the electronic device may display the graphical user interface in the transient state of the first view mode. The scaling process of the multiple icons may be achieved in the form of animation to achieve smooth adjustment of icon sizes, thereby achieving a visual effect of smooth transition or expressing the changes of icons by a series of continuous image frames.

It can be understood that, the present disclosure does not impose any specific limitations on the implementation of the zoom processing, and specific implementations of the zoom processing can be configured based on actual application scenarios. In some examples, a current display size of at least one icon is determined based on the preset icon display size corresponding to the first view mode and a current instruction of the zoom operation, such as a zoom ratio currently instructed by the zoom operation. In some other examples, a current display size of at least one icon is determined based on the preset icon display size corresponding to the first view mode, an adjacent preset icon display size, as well as a current instruction of the zoom operation. For instance, the plurality of preset view modes include the first view mode and a second view mode, where the preset icon display size corresponding to the first view mode is “a”, and the preset icon display size corresponding to the second view mode is “b”. The user is intended to switch the graphical user interface from the first view mode to the second view mode, during the zoom operation of the user for instructing to switch from the first view mode to the second view mode, if a zoom ratio currently instructed by the zoom operation is “scale”, then a current display size “c” of the icons may be determined based on the following Equation 1:

$$c = a + ( b - a ) \times scale \qquad ( Equation 1 )$$

In some implementations, a central icon located in the center of the display area in the graphical user interface is identified, and the center icon is still displayed in the center of the display area after the zoom processing is performed on the plurality of icons.

In some other implementations, the display mode of the graphical user interface is switched in real-time during the zoom operation of the user on the electronic device. If a current zoom instruction corresponding to the zoom operation satisfies a mode switching condition, such as, for example, a zoom ratio or icon display size currently instructed by the zoom operation matches a zoom ratio of preset display size corresponding to another preset view mode, the electronic device may switch the display mode of the graphical user interface. Before the switch, the icons may be always displayed with the preset icon display size corresponding to the current view mode. For example, during the continuous zoom operation, it is determined whether to switch the view mode of the graphical user interface based on the current view mode as well as a zoom ratio or an icon display size currently instructed by the zoom operation. For instance, if the current view mode is the minimum view mode, and the zoom ratio or the icon display size currently instructed by the zoom operation is smaller than a zoom ratio or a preset icon display size corresponding to the intermediate view mode, it is determined that switching of the current view mode is not performed. The graphical user interface continues to be displayed in the minimum view mode, and a plurality of icons are displayed with the preset icon display size corresponding to the minimum view mode. For another example, if the current view mode is the minimum view mode, and the zooming scale or icon display size currently instructed by the zoom operation is greater than or equal to the zooming scale or preset icon display size corresponding to the intermediate view mode, it is determined to switch the display mode of the graphical user interface to the intermediate view mode.

In some other implementations, the icons in the graphical user interface are gradually scaled from one view mode to another as the zoom operation continues. That is, during the continuation of the zoom operation, the electronic device may progressively scale and display at least one icon displayed in the first view mode based on the zoom ratio or icon display size currently instructed by the zoom operation, and responsive to the zoom ratio or icon display size currently instructed by the zoom operation reaches the zoom ratio or preset icon display size corresponding to another view mode, switch the graphical user interface from the first view mode to another view mode for display.

In some implementations, during the zoom operation, the electronic device may change the display sizes and/or layout of the icons in the graphical user interface. In some cases, the electronic device may switch the display mode from the first view mode to another view mode included or not included in the plurality of preset view mode. The electronic device may change the display sizes of the plurality of icons while the graphical user interface is displayed in the first view mode, such that the display sizes of the plurality of icons are different from the preset icon display size corresponding to the first view mode. For example, the icon display size currently instructed by the zoom operation is determined based on the preset icon display size corresponding to the first view mode, the preset icon display size corresponding to an adjacent view mode, and the zoom ratio or an icon display size currently instructed by the zoom operation, such as by the above equation (1). As the zoom operation continues, the icon display size currently instructed by the zoom operation may gradually change. For another example, after the electronic device zooms in or zooms out at least a part of the plurality of icons according to the current zoom instruction or current instructed zoom ratio, the display sizes of the icons are increased or decreased, and it is possible that more or less of the icons are in the display area of the electronic device and visible to users.

In some other examples, during the continuation of the zoom operation, the electronic device displays, in response to the icon display size currently instructed by the zoom operation being between the preset icon display size corresponding to the first view mode and the preset icon display size corresponding to an adjacent view mode, the graphical user interface in the first view mode, and display a plurality of icons based on the currently instructed icon display size. In other words, the view mode does not switch immediately, but the icon display size is adjusted synchronously with the zoom operation of the user, which can maintain the visual continuity of the user interface, achieve a smooth transition effect, avoid sudden changes, reduce discomfort of the user, and make it easier for the user to adapt to the new view mode.

Considering that transitioning from one view mode to another may cause users to feel visually inconsistent, or in order to allow users to preview the display changes in the graphical user interface caused by the zoom operation, the display sizes of the icons may be gradually adjusted during the zoom operation on the electronic device. In some examples, the adjustment of display sizes can be made smoothly with a transitional effect or animation. Through the gradual adjustment, the user may gradually adapt to the new view mode and the discomfort associated with abrupt changes is reduced. During the gradual adjustment, the display sizes of multiple icons in the graphical user interface may differ from the preset icon display size corresponding to the first view mode.

In some examples, while the zoom operation is still ongoing, based on the current zoom ratio or the current zoom instruction corresponding to the zoom operation, the display sizes of the icons can be enlarged or reduced on the basis of the preset icon display size corresponding to the first view mode, and the display sizes of the icons may be different from any preset icon display size corresponding to the plurality of preset view modes. In this case, there can be one or more transitional view modes between two adjacent preset view modes. In a transitional view mode, display sizes of the plurality of icons can be the same or different, and the display sizes of the icons in the transitional view mode can be obtained by proportionally zooming the plurality of icons in a preset view mode, or by other means such as calculated according to the Equation 1 above. For instance, there are one or more transitional states between the minimum view mode and the intermediate view mode with the display sizes of at least a part of the icons gradually increasing from the preset icon display size corresponding to the minimum view mode to the preset icon display size corresponding to the intermediate view mode. For another instance, there are one or more transitional states between the intermediate view mode and the maximum view mode with the display size of at least a part of the icons gradually increasing from the preset icon display size corresponding to the intermediate view mode to the preset icon display size corresponding to the maximum view mode. In this case, while the zoom operation continues, the graphical user interface may be displayed in a transitional view mode other than the plurality of preset view modes. Therefore, while the zoom operation continues, the graphical user interface may be displayed in one of the plurality of preset view modes, or displayed in a transitional view mode. While after the electronic device detects completion of the zoom operation, the graphical user interface is always displayed in one of the plurality of preset view modes.

In some other implementations, the transitional view mode mentioned above can be treated as a transient state of a preset view mode. In this case, a preset view mode can have a steady state and a transient state. In the steady state of a preset view mode, the display sizes of icons are the same as the preset icon display size corresponding to the preset view mode. In the transient state of a preset view mode, the display sizes of icons are different from the preset icon display size corresponding to the preset view mode. For example, the display sizes of icons in a transient state of a preset view mode can be obtained by zoom in or zoom out the plurality of icons in the steady state of the preset view mode in equal proportions, thereby maintaining a consistent layout for the preset view mode. A transient state of a preset view mode is a transitional state between the preset view mode and an adjacent preset view mode, and in the transient state of the preset view mode, a display size of the icons falls between the preset icon display size corresponding to the preset view mode and the preset icon display size corresponding to an adjacent preset view mode. Therefore, while the zoom operation continues, the graphical user interface may be displayed in the steady state of a preset view mode, or displayed in a transient state of a preset view mode. While after the electronic device detects completion of the zoom operation, the graphical user interface is always displayed in the steady state of a preset view mode.

In the present disclosure, the implementations of the present disclosure are illustrated by taking the preset view mode with a steady state and a transient state mentioned above as an example, but the present disclosure is not limited thereto.

In some implementations, to provide greater flexibility and personalized choices while ensuring the reasonableness of icon display, the icons can continue to be zoomed in within a certain zooming range on the basis of the preset icon display size corresponding to the maximum view mode.

During the continuous zoom operation, responsive to the graphical user interface currently being displayed in the maximum view mode, which corresponds to the maximum preset view display size among multiple preset view modes, and to the zoom operation currently instructs to further zoom in, the electronic device enlarges and displays at least a part of the plurality of icons based on the currently instructed zoom ratio and a zoom-in ratio threshold. On one hand, users can continue to enlarge icons according to their personal preferences and needs, providing greater flexibility and personalized choices, allowing users to customize the icon display size to fit different screen sizes or personal visual preferences. On the other hand, by limiting the zoom in operation with the zoom-in ratio threshold, interface inconsistency potentially caused by excessively large icons can be avoid, ensuring the reasonableness of icon display.

For example, if the zoom ratio currently instructed by the zoom operation is less than the zoom-in ratio threshold, the electronic device enlarges and displays multiple icons according to the currently instructed zoom ratio. For another example, if the zoom ratio currently instructed by the zoom operation is greater than or equal to the zoom-in ratio threshold, the electronic device enlarges and displays multiple icons according to the zoom-in ratio threshold.

In some implementations, to provide greater flexibility and personalized options while ensuring the reasonableness of icon display, further reduction of icon display size from the preset icon display size corresponding to the minimum view mode is allowed, but limited to within a certain zoom-out range.

During the continuous zoom operation, in response to the graphical user interface currently being displayed the minimum view mode, which corresponds to the smallest preset view display size in the multiple preset view modes, and to the zoom operation currently instructing to further zoom out, the electronic device zooms out and displays at least a part of the plurality of icons based on the currently instructed zoom ratio and a zoom-out ratio threshold. On one hand, this provides users with the flexibility and personalized options to further reduce icon sizes according to their preferences and needs, allowing users to customize the icon display size for different screen sizes or personal visual preferences. On the other hand, the restriction of the zoom-out ratio threshold avoids interface confusion potentially caused by too small icons, and ensures that the icon display remains reasonable.

For example, if the zoom ratio currently instructed by the zoom operation is greater than the zoom-out ratio threshold, the electronic device reduces the display size of multiple icons and displays the icons based on the currently instructed zoom ratio. For another example, if the zoom ratio currently instructed by the zoom operation is less than or equal to the zoom-out ratio threshold, the electronic device reduces the display size of multiple icons and displays the icons based on the zoom-out ratio threshold.

In some implementations, during the continuous zoom operation, the display sizes of the icons in a preset view mode may be the same as the preset icon display size corresponding to the preset view mode, and alternatively, the display sizes of the icons may be enlarged or reduced on the basis of the preset icon display size corresponding to a preset icon display size. However, after the zoom operation is completed, the display sizes of the icons in the target view mode are always the same as the preset icon display size corresponding to a preset view mode, i.e., the preset icon display size corresponding to the target view mode.

Several possible scenarios of the present application are illustrated below.

In one possible case, at the end of the zoom operation, the graphical user interface is displayed in a transitional state between two adjacent preset view modes. For example, if the zoom operation instructs to zoom in, and the graphical user interface is displayed in a transient state of a second view mode at the end of the zoom operation, then the second view mode is determined as the target view mode. Alternatively, the target view mode is selected from these two preset view modes. For another example, a current display size of the icons at the end of the zoom operation is determined, and the target view mode is determined based on a difference between the current display size of the icons and a preset icon display size corresponding to the second view mode, and/or a difference between the current display size of the icons and a preset icon display size corresponding to an adjacent view mode of the second view mode. For another example, a zoom instruction corresponding to the end of the zoom operation is determined, and the target view mode is determined based on the zoom ratio or icon display size instructed at the end of the zoom operation as well as the zoom ratios or preset icon display sizes corresponding to the plurality of preset view modes.

In another possible case, at the end of the zoom operation, the graphical user interface is still displayed in the first view mode, and the icons are displayed with a size different from the preset icon display size corresponding to the first view mode. In this case, the first view mode may be determined as the target view mode, and at least one icon in the graphical user interface is displayed with the preset icon display size corresponding to the first view mode. Alternatively, the target view mode is determined based on at least one of the current display size of the icons at the end of the zoom operation or a current zoom instruction at the end of the zoom operation, and at least one icon is displayed with a preset icon display size corresponding to the target view mode.

In another possible case, the user continues to enlarge the icons on the basis of the maximum view mode. For instance, at the end of the zoom operation, the graphical user interface is displayed in the maximum view mode, and at least one icon is displayed with a size larger than the preset icon display size corresponding to the maximum view mode. In this case, the maximum view mode is determined as the target view mode, and accordingly, after the zoom operation is completed, at least one icon is displayed with the preset icon display size corresponding to the maximum view mode.

In another possible case, the user continues to reduce the icons on the basis of the minimum view mode. For instance, at the end of the zoom operation, the graphical user interface is displayed with the minimum view mode, and at least one icon is displayed with a size less than the preset icon display size corresponding to the minimum view mode. In this case, the minimum view mode is determined as the target view mode, and accordingly, after the zoom operation is completed, at least one icon is displayed with the preset icon display size corresponding to the minimum view mode.

In some implementations, considering the size limitation of the display area of the electronic device, as in FIGS. 3 to 5, the plurality of icons included in the graphical user interface may not all be displayed in the display area of the electronic device, and it is possible that some of the icons are displayed in the display area of the electronic device, while others are not displayed in the display area of the electronic device. Therefore, in order to save computing resources of the electronic device, the scaling process may be performed only on the icons displayed in the display area of the electronic device, or to be displayed in the display area of the electronic device, which not only saves the computing resources of the electronic device, but also is conducive to improve processing efficiency.

In some implementations, while the graphical user interface is displayed in a particular view mode, the user may move the display position of the graphical user interface, i.e., the plurality of icons in the graphical user interface are translated. The electronic device may receive an icon moving operation from the user and display the graphical user interface based on the icon moving operation. In some cases, at least a part of the graphical user interface may be moved outside the display area of the electronic device. If a degree of overlap between a target area of the plurality of icons instructed by the icon moving operation and a display area of the electronic device is less than a first overlap threshold, at least two edge icons of the plurality of icons are moved into the display area of the electronic device for display. In this way, no matter how the user moves, there are always at least two icons displayed in the display area of the electronic device, which avoids all the icons being moved out of the display area of the electronic device and causing the user to feel confused or needing additional operations to find the desired icons. Moreover, keeping at least one icon in the display area of the electronic device helps to improve the visual balance and layout of the interface, avoiding an excessive blank area or visual asymmetry.

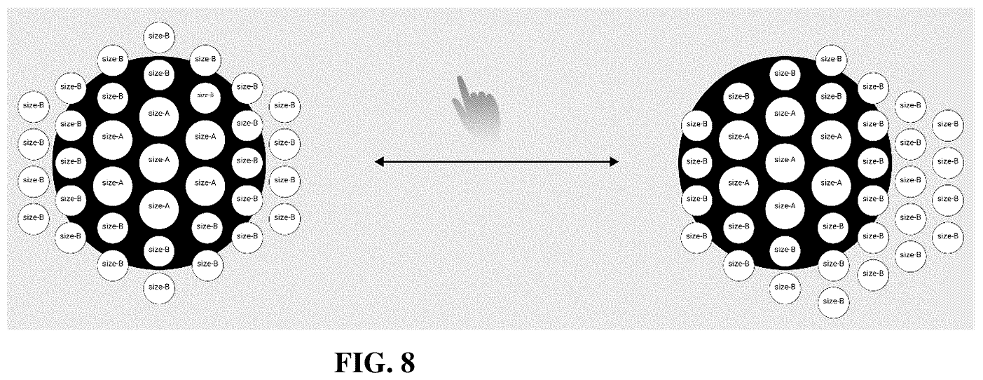

In some implementations, referring to FIG. 8, the graphical user interface displayed in a preset view mode includes at least two center icons displayed with a first size and at least two surrounding icons displayed with a second size, where the first size is larger than the second size. After receiving an icon moving operation, the electronic device may still display the graphical user interface in the current preset view mode. For example, the electronic device determines, based on the detected icon movement operation of the user, at least two second center icons located in the central region after the movement and at least two second peripheral icons located in the peripheral region after the movement, and displays the at least two second center icons with the first size and the at least two second peripheral icons with the second size. In this way, the icons displayed in the central region of the display area are always larger than the icons displayed in the peripheral region.

In order to avoid the problem of abrupt visual changes caused by directly changing the display sizes of the plurality of icons between the first size and the second size, during the continuation of the icon movement operation, the electronic device may determine a size adjustment ratio based on a distance between a first center icon originally positioned in the center region and the center of the display area, and then carry out a size adjustment processing on the first center icon according to the size adjustment ratio. Alternatively, the electronic device may determine a size adjustment ratio based on a distance between the second center icon to be moved to the center region of the display area and the center of the display area, and then perform the size adjustment processing on the second center icon based on the size adjustment ratio. Through progressive adjustment of display sizes of the icons, the user can gradually adapt to the new icon size and reduce the discomfort caused by sudden changes.

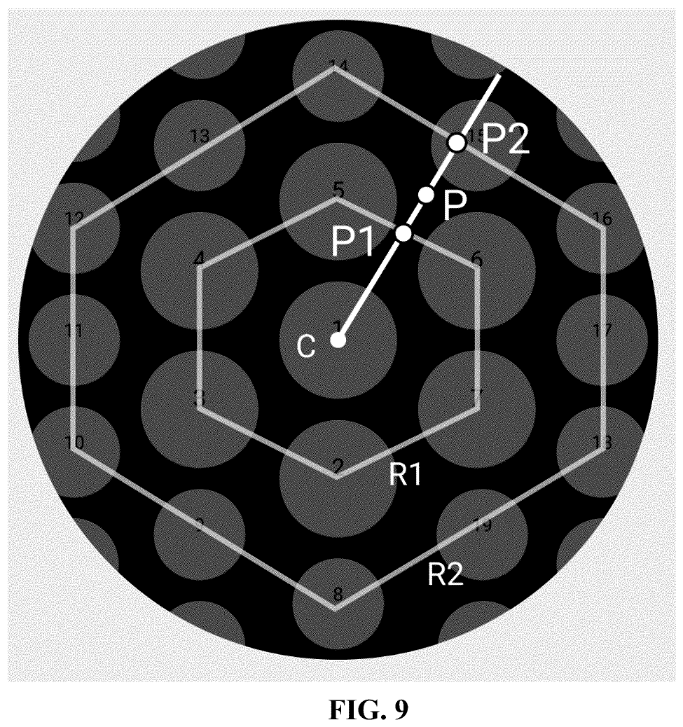

In the following, a possible implementation of determining display sizes of the plurality of icons in response to the icon movement operation is provided. In some examples, the display sizes of only a portion of the plurality of icons are adjusted, while the display size of the other portion of the plurality of icons are unchanged, so as to reduce the computation amount of the electronic device. Referring to the example shown in FIG. 9, the plurality of icons include the first center icon (e.g., icon 1) currently located at the center C of the display area, as well as multiple icons located on a plurality of hexagons. The first center icon and the icons (e.g., icon 2 to icon 7) located on the first hexagon are displayed with the first size, while other icons, including the icons located on the second hexagon, are displayed with the second size. In one example, in response to the icon movement operation, the adjustment processing of display sizes is performed on the icons located on the first and second hexagons as well as the first center icon, and the display sizes of the icons are adjusted gradually. For example, a gradual change of the display sizes of the icons is implemented by utilizing an interpolation method or the like. In FIG. 9, P is an arbitrary position located between the first hexagon and the second hexagon, P1 denotes an intersection of a straight line connecting P and C with the first hexagon, and P2 denotes an intersection of the straight line connecting P and C with the second hexagon. It is assumed that a distance from P2 to P1 is R, and a distance from P to P2 is R1. If an icon is moved from the first hexagon to P, or moved from the second hexagon to P, the display size of the icon needs to be adjusted, and an adjustment ratio of the display size of the icon, s, can be determined by the following formula:

$$s = R 1 / R . \qquad ( Equation 2 )$$

It is assumed that, the first size is sizeA, the second size is sizeB, and the first center icon is moved to P, then the adjusted display size of the first center icon, sizeE, can be determined by the following formula:

$$sizeE = sizeA + s \times ( sizeB - sizeA ) . \qquad ( Equation 3 )$$

Similarly, assuming that the second center icon is moved to the point P, then the adjusted display size of the second center icon, sizeF; can be determined by the following formula:

$$sizeF = sizeB + s \times ( sizeA - sizeB ) . \qquad ( Equation 4 )$$

In this way, the computational complexity of the electronic device can be reduced while improving the visual experience of users.

In some implementations, during the continuation of the icon movement operation, the plurality of icons are moved in real-time according to the current move instruction of the icon movement operation. The electronic device may determine a distance between the first center icon and the center of the display area based on an offset currently instructed by the icon movement operation, and determine a current display position of the first center icon. Similarly, the electronic device may determine a distance between the second center icon and the center of the display area based on the offset currently instructed by the icon movement operation, and determine a current display position of the second center icon.

In some implementations, the plurality of icons in the graphical user interface may be managed based on the instruction of users.

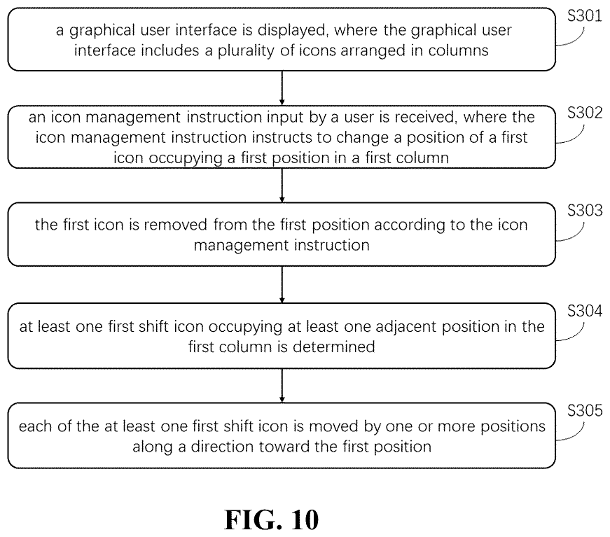

Another method for icon display provided by the present disclosure is illustrated in conjunction with examples. Reference is made to the process illustrated in FIG. 10. The method may be performed by an electronic device. The method includes the following procedures.

At S301, a graphical user interface is displayed, where the graphical user interface includes a plurality of icons arranged in columns.

The graphical user interface includes a plurality of locations spaced and arranged in multiple columns. In each column, there is one or more locations being occupied by an icon, where the icon may denote an application, a function or the like. In some examples, referring to FIG. 4 and FIG. 5, icons in adjacent columns are arranged in an interleaved manner, such that the plurality of icons are arranged in a configuration including a plurality of rings surrounding each other, each ring includes at least two icons located in at least two columns. The rings may be in circular, hexagonal, or other polygonal shapes, which is not limited herein. Furthermore, the plurality of icons may be displayed with a same size or with different sizes, which is not limited herein.

In some examples, referring to FIG. 5, the plurality of icons include a plurality of center icons displayed with a first size and a plurality of surrounding icons displayed with a second size, the first size being greater than the second size. The plurality of surrounding icons are arranged around the plurality of center icons, and the plurality of center icons are positioned in a plurality of columns.

At S302, an icon management instruction input by a user is received, where the icon management instruction instructs to change a position of a first icon occupying a first position in a first column.

The first column may include a plurality of icons. The first icon occupies a first position of the first column, where the first position may be any position in the first column, such as an edge position, a position located between two edge positions, or the like.

The icon management instruction is detected by the electronic device. In some implementations, the electronic device detects a contact gesture on the touch-sensitive screen. For instance, the electronic device detects a contact on the first position. Alternatively, the electronic device detects a non-contact gesture, or detects a press on a button, or detects a rotation on a crown, or the like.

The icon management instruction is used for managing the configuration of the plurality of icons in the graphical user interface, and instructs to change a position of the first icon. For example, the icon management instruction may be an icon deletion instruction instructing to delete the first icon. For another example, the icon management instruction may be an icon move instruction instructing to move the first icon from the first position to another position. For another example, the icon management instruction may be an icon move instruction instructing to put another icon in the first position.

At 303, the first icon is removed from the first position according to the icon management instruction.

At S304, at least one first shift icon occupying at least one adjacent position in the first column is determined.

The at least one first shift icon includes one or more icons in the first column. The at least one first shift icon may include multiple icons occupying adjacent positions in the first column. The number of icons included in the at least one first shift icon may be pre-determined. Alternatively, the number of icons included in the at least one first shift icon may depend on the location of the first position in the first column. In some examples, the at least one first shift icon includes multiple adjacent icons from a second icon to an edge icon of the first column, where the multiple adjacent icons occupy adjacent positions located in a first direction from the first position, and the second icon may occupy a position adjacent or not adjacent to the first position. The first direction may be preset, for instance, the first direction is a direction upward from the first position in the first column. For example, referring to FIG. 4, it is assumed that the first icon is icon 1, then the first direction is a direction from icon 1 towards the icon 29. Alternatively, the first direction is a direction downward from the first position in the first column. Assuming that the first icon is icon 1 in FIG. 4, then the first direction is a direction from the icon 1 points towards the icon 20. Alternatively, the first direction may depend on the location of at least one of the first position and the first column.

At S305, each of the at least one first shift icon is moved by one or more positions along a direction toward the first position.

In some examples, the at least one first shift icon is translated by one or more positions along a direction toward the first position, e.g., along a second direction opposite to the first direction. In some examples, the at least one first shift icon includes a second icon occupying a position adjacent to the first position. For instance, the at least one first shift icon includes at least one icon occupying at least one adjacent position from a position adjacent to the first position to an edge position, that is, the at least one first shift icon includes at least one icon from the second icon to an edge icon along a first direction of the first column. In this case, each of the at least one first shift icon may be moved toward the first position by one position, such that each first shift icon is moved to a position in the first column adjacent to its original position, and the second icon is moved to the first position.

As an example, it is assumed that the first icon is icon 1 in FIG. 4, the first direction is the direction from the icon 1 towards the icon 29, and the at least one first shift icon include icon 5, icon 14 and icon 29. After the icon 1 is removed from its original display position, the at least one first shift icon is translated by one position along a direction opposite to the first direction. Therefore, the icon 5, which is adjacent to the icon 1 and served as the second icon, is moved to the original display position of the icon 1. The icon 14 is moved to the original position of icon 5, and the icon 29 is moved to the original position of icon 14.

In the implementations, after the first icon in the first column is removed from its original position, at least one first shift icon in the first column is shifted sequentially to fill the gaps. On the one hand, visual continuity can be maintained, and by sequentially moving the at least one first shift icon in the first column to fill the gaps, the overall layout of the graphical user interface maintains continuity and stability, avoiding abrupt changes or misalignments of the icons, and making the user feel more comfortable and natural during interaction with the graphical user interface. On the other hand, it is beneficial to preserve user habits and familiarity. Users usually form certain usage habits and memory patterns, and are accustomed to specific icons appearing in specific locations. By sequentially shifting the positions of the icons, the relative position of at least one first shift icon in the first column is kept as unchanged as possible, making it easier for the users to locate and recognize the desired icons without the need for re-adjustment or adaptation to new habit.

In some implementations, the icon management instruction includes a first icon move instruction directing to move the first icon to a second position in the second column, where the second column is different from the first column, and the second position is occupied by another icon. In response to the first icon move instruction, the electronic device may move the first icon from the first position in the first column to the second position in the second column. Furthermore, the electronic device may determine at least one first shift icon in the first column and at least one second shift icon in the second column, move the at least one first shift icon toward the first position, and move each of the at least one second shift icon by one or more positions, such that one of the at least one second shift icon is moved to an edge position of the first column.

The at least one second shift icon includes one or more icons in the second column. The at least one second shift icon may include multiple icons occupying adjacent positions in the second column. The number of icons included in the at least one second shift icon may be pre-determined. Alternatively, the number of icons included in the at least one second shift icon may depend on at least one selected from a group including the location of the first position in the first column, the location of the second position in the second column, the location of the second column, the location of the first column, or an interval between the first and the second columns. In some examples, the at least one second shift icon includes multiple adjacent icons from a third icon to an edge icon of the second column, where the multiple adjacent icons occupy adjacent positions located in a same direction from the second position, which is the same as the first direction or opposite to the first direction, and the third icon may occupy the second position, or occupy a position adjacent or not adjacent to the second position.

In some examples, one or more of the at least one second shift icon is translated by one or more positions along a direction away from the second position. For instance, one or more of the at least one first shift icon is translated along a direction opposite to a translation direction of the at least one first shift icon, such that the at least one second shift icon is shifted sequentially to fill the vacant positions in the first column and the second column. In some other examples, one or more icons included in the at least one second shift icon is moved to the first column, so as to fill one or more vacant positions produced by movement of the at least one first shift icon.

As an example, the at least one second shift icon includes at least one adjacent icon from the third icon occupying the second position to an edge position of the second column, and each of the at least one second shift icon may be moved by one position along a direction away from the second position, such that the second position is vacant and is available for the first icon.

In the implementations, in the cases that the first icon move instruction is detected, the icons in the first column and in the second column are moved, while positions of the icons in other columns remain unchanged. On one hand, users can maintain a stable perception of the icons in other columns during operation, and instead of having to re-adapt or retrieve their previous positions, they can focus on the icons being moved, which helps provide predictable interface behavior. Users can anticipate the positions of the icons based on their previous experiences and memories without being confused by unexpected large-scale changes. Additionally, this approach can reduce the disturbances and unnecessary complexity, making it easier for users to understand and accept the changes. On the other hand, making adjustments to only two columns can simplify the process of moving icons. The user only needs to focus on the columns involved and the associated icons, rather than having to deal with the rearrangement of multiple columns and a large number of icons simultaneously.

In some examples, the at least one first shift icon includes at least one icon from the second icon to a first edge icon along the first direction. The at least one second shift icon includes at least one icon in the second column from a third icon to a second edge icon along the first direction or the second direction.

In some implementations, after the at least one first shift icon is moved toward the first position, at least one position near the edge of the first column is vacant. For instance, the first edge position, which is originally occupied by the first edge icon, is vacant. In this case, during the process of moving the at least one second shift icon in the second column, in a possible scenario, at least one of the at least one second shift icon is moved to the vacant position in the first column. For instance, a second edge icon, which occupies an edge position of the second column and is included in the at least one second shift icon, is moved to the first edge position, thereby filling a vacant position left in the first column after the at least one first shift icon is moved. In another possible scenario, after the second edge icon is moved to the first column, other icons in the at least one second shift icon may be translated by one or more positions along a direction away from the second position. For instance, a second shift icon is moved to a position adjacent to its original position, so that the relative positions between the second shift icons remain unchanged, which is beneficial for maintaining user habits and familiarity.

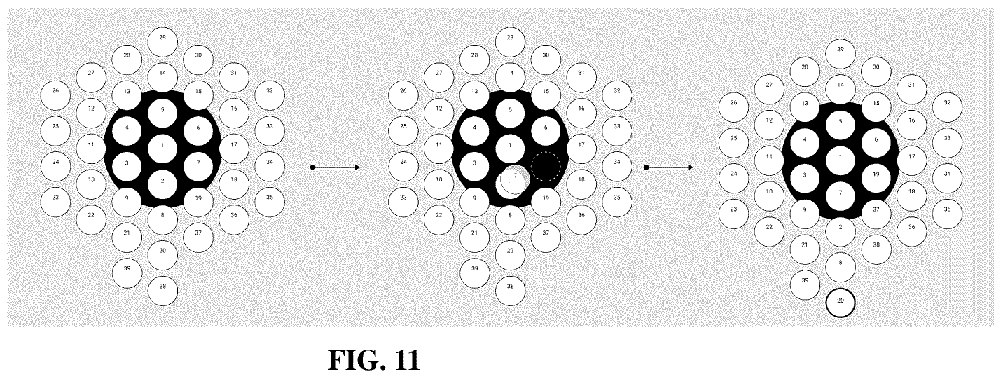

In an example, referring to FIG. 11, it is assumed that the first icon move instruction instructs to move the icon 7 occupying a first position to a second position occupied by icon 2. The electronic device may determine that the at least one first shift icon includes icon 19 and icon 37, and determine that the at least one second shift icon includes icon 2, icon 8, icon 20, and icon 38. The icon 7 is removed from the first position, each of the icon 19 and the icon 37 is moved up by one position, such that a first edge position, i.e., an original position of the icon 37, is vacant. The icon 38 is moved to the first edge position, and each of the icon 2, the icon 8 and the icon 20 are moved down by one position, such that the second position is vacant and is available for by the icon 7. In this way, the configuration of the graphical user interface remains unchanged.

In another example, referring to FIG. 11, it is assumed that the first icon move instruction instructs to move the icon 7 occupying the first position to a second position occupied by the icon 2. The electronic device may determine that the at least one first shift icon includes icon 6, icon 15, and icon 30, and determine that the at least one second shift icon includes icon 2, icon 1, icon 5, icon 14, and icon 29. The icon 7 is removed from the first position, each of the icon 6, icon 15, and icon 30 is translated down by one position, such that the first position is occupied by the icon 6, and the first edge position originally occupied by the icon 30 is vacant. The icon 29 is moved to the first edge position, and each of the icon 2, icon 1, icon 5, and icon 14 is translated up by one position, such that the second edge position originally occupied by the icon 29 is occupied by the icon 14, and the second position originally occupied by icon 2 is vacant and available for the icon 7.

In another example, referring to FIG. 4, it is assumed that the first icon move instruction instructs to move icon 37 occupying a first edge position to a second position occupied by icon 8. The electronic device may determine that the number of icons included in the at least one first shift icon is zero, and the at least one second shift icon includes icon 8 and icon 20. The icon 37 is removed from the first edge position, the icon 20 is moved to the first edge position, and each of the icon 8 and icon 2 is translated down by one position, such that the second position is available for the icon 37.

In another example, referring to FIG. 4, it is assumed that the first icon move instruction instructs to move icon 37 to the second position occupied by the icon 8, and the first direction is a direction from the icon 37 to the icon 30. The electronic device may determine that the at least one first shift icon includes icon 19, icon 7, icon 6, icon 15, and icon 30, and the at least one second shift icon includes icon 8, icon 2, icon 1, icon 5, icon 14, and icon 29. The icon 37 is removed from its original position, each of the icon 19, icon 7, icon 6, icon 15, and icon 30 is translated down by one position, such that a first edge position occupied by the icon 30 is vacant. The icon 29 is moved to the first edge position, and each of the icon 8, icon 2, icon 1, icon 5, and icon 14 is translated up one position, such that the second position is available for the icon 37.

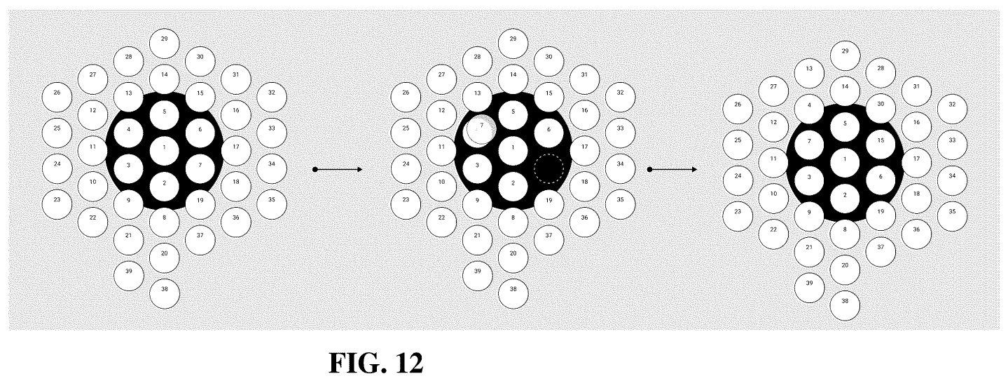

In another example, referring to FIG. 12, it is assumed that the first icon move instruction instructs to move the icon 7 to a second position occupied by the icon 4. The electronic device may determine that the at least one first shift icon includes icon 6, icon 15, and icon 30, and the at least one second shift icon includes icon 4, icon 13, and icon 28. The icon 7 is removed from its original position, the icon 6, the icon 15 and the icon 30 are translated down by one position, the icon 28 is moved to the original position of the icon 30, and the icon 4 and the icon 13 are translated up by one position, such that the icon 7 can be moved to the original position of the icon 4.

In another example, it is assumed that the first icon move instruction instructs to move the icon 7 to a second position occupied by the icon 4. The electronic device may determine that the at least one first shift icon includes icon 6, icon 15, and icon 30, and the at least one second shift icon includes icon 4, icon 3, icon 9, icon 21 and icon 39. The icon 7 is removed from its original position, the icon 6, icon 15, and icon 30 are translated down by one position, the icon 39 is moved to the original position of the icon 30, and the icon 4, icon 3, icon 9, and icon 21 are translated down by one position.

In some implementations, the icon management instruction includes a second icon move instruction instructing to move the first icon to a second position occupied by a third icon in the first column. In response to the second icon move instruction, the electronic device may determine at least one first shift icon. The at least one first shift icon may include one or more icons occupying at least one adjacent position between the first position and the second position. The electronic device may remove the first icon from the first position, and move the at least one first shift icon by one or more positions toward the first position.

In some examples, the at least one first shift icon includes at least one adjacent icon from a second icon occupying a position adjacent to the first position to the third icon, and the electronic device may translate the at least one first shift icon by one position toward the first position, and move the first icon to the second position. In the implementations, sequential shifting of icons within the same column is realized, keeping the relative positions of the icons unchanged, which is conducive to maintaining user habits and familiarity.

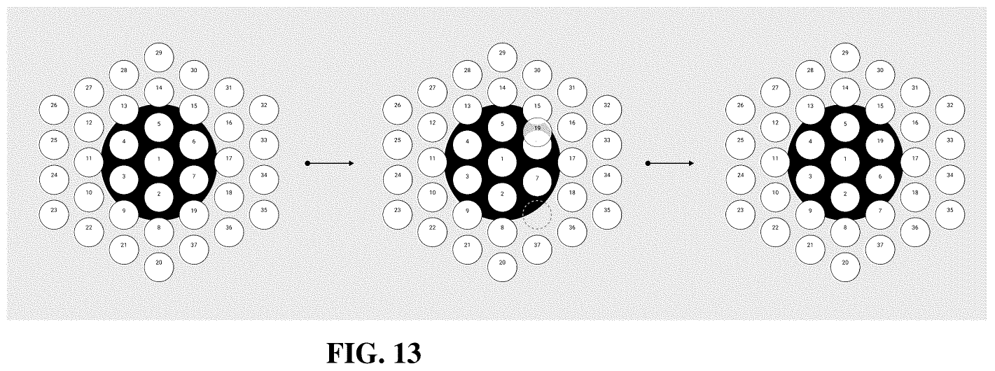

In one example, referring to FIG. 13, the second icon move instruction instructs to move icon 19 to a second position occupied by icon 6. The electronic device may determine that the at least one first shift icon includes icon 7 and icon 6, and move the icon 19 to the second position. Meanwhile, the electronic device translates each of the icon 6 and the icon 7 down by one position to achieve sequential shifting and filling of vacancies in the column.

In some implementations, the icon management instruction includes an icon deletion instruction. In response to the icon deletion instruction, the electronic device may remove the first icon from the first position, and move the at least one first shift icon in the first column by one or more position toward the first position. In some examples, the at least one first shift icon includes at least one adjacent icon from a second icon occupying a position adjacent to the first position to an first edge icon of the first column. The electronic device may remove the first icon, and translate the at least one first shift icon to sequential fill the vacancies in the first column, which is conducive to maintaining the overall layout of the column in a neat and orderly manner, avoiding hollow or sparse layouts, and enabling the user to browse and locate the icons more easily.

After the at least one first shift icon in the first column is sequentially moved to a vacant position in the first column, there may be one or more vacant positions at the edge of the first column. For example, a first edge position originally occupied by the first edge icon may be vacant. In this case, if the first column is not an edge column, the electronic device may determine at least one second shift icon in a second column, and move each of the at least one second shift icon by one or more positions, so as to fill the one or more vacancies produced in the first column. In some examples, the second column may be an edge column located at the edge of the plurality of columns, and accordingly, the at least one second shift icon may include an edge icon occupying an edge position of the second column, or include at least one icon occupying at least one adjacent position in the second column. In some other examples, the second column may be an adjacent column of the first column, and accordingly, the at least one second shift icon may include at least one adjacent icon including an edge icon of the second column. In some other examples, the second column may be a column where an icon with the largest number of the plurality of icons is located, and accordingly, the at least one second shift icon may include the icon with the largest number, or include an edge icon in the second column. In some examples, the at least one second shift icon may be moved to the first edge position, which is conducive to further maintaining the overall layout of the column in a neat and orderly manner, avoiding the emergence of vacant holes or sparse layout.

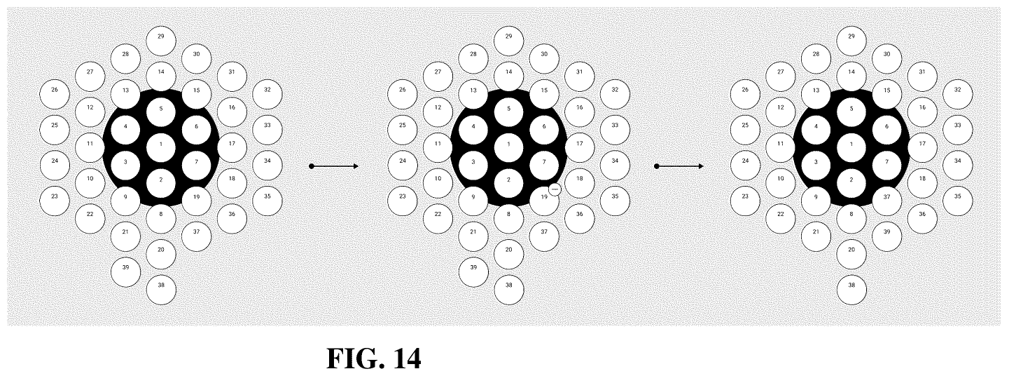

In one example, referring to FIG. 14, the icon deletion instruction instructs to delete icon 19. The electronic device may determine that the at least one first shift icon includes icon 37, and the at least one second shift icon includes icon 39 having a largest number among the plurality of icons. The electronic device may delete the icon 19, move the icon 37 up by one position to the original position of the icon 19, and move the icon 39 to the original position of the icon 37.

In another example, referring to FIG. 4, the icon deletion instruction instructs to delete the icon 19. The electronic device may determine that the at least one first shift icon includes icon 7, icon 6, icon 15, and icon 30, and the at least one second shift icon includes icon 29 having a largest number in a column adjacent to the first column. The electronic device may delete the icon 19, translate each of the icon 7, the icon 6, the icon 15, and the icon 30 down by one position, and move the icon 29 to a first edge position, i.e., the original position of the icon 30.

In some implementations, the plurality of icons includes a plurality of center icons displayed with a first size and a plurality of surrounding icons displayed with a second size. The first size is larger than the second size. The plurality of surrounding icons are arranged around the plurality of center icons, and the plurality of center icons are located in a plurality of columns. Alternatively, the plurality of icons are arranged on a plurality of rings surrounding each other, each ring including at least two icons located in at least two columns.

The various technical features in the above implementations can be combined arbitrarily, as long as there is no conflict or contradiction between the features, which however are not described individually due to space limitations. Therefore, the arbitrary combination of the various technical features in the above implementations falls into the scope of the disclosure.

Corresponding to the foregoing implementations of the method for icon display, the present disclosure provides an electronic device as well as a storage medium.

The present disclosure provides an electronic device including a processor, and a memory storing executable instructions. When the executable instructions are executed by the processor, at least a part of the method mentioned above is implemented.

In some implementations, the processor is configured to cause the electronic device display a graphical user interface in a first view mode. The graphical user interface includes a plurality of icons. The electronic device supports a plurality of preset view modes including the first view mode. Different preset view modes of the plurality of preset view modes correspond to different preset icon display sizes.

The processor is further configured to detect a zoom operation on the electronic device by a user.

The processor is further configured to zoom and display at least a part of the plurality of icons according to current instruction of the zoom operation while the zoom instruction continues.

The processor is further configured to determine, in response to detecting completion of the zoom operation, a target view mode from the plurality of preset view modes, and display at least a part of the plurality of icons with a preset icon display size corresponding to the target view mode.

In some other implementations, the processor is configured to display a graphical user interface, where the graphical user interface includes a plurality of icons arranged in columns.

The processor is further configured to receive an icon management instruction from a user, where the icon management instruction instructs to manage a position of a first icon occupying a first position, and the first position is located in a first column.

The processor is further configured to remove the first icon from the first position according to the icon management instruction.

The processor is further configured to determine at least one first shift icon in the first column, wherein the at least one first shift icon occupies at least one adjacent position in the first column.

The processor is further configured to move each of the at least one first shift icon by one or more positions along a direction toward the first position.

The present disclosure also provides a computer-readable storage medium having one or more computer programs stored thereon. When the one or more computer programs are executed by a computer, the computer implements at least a part of the method mentioned above.

The present disclosure may take the form of a computer program product implemented on one or more storage media (including, but not limited to, disk memory, CD-ROM, optical memory, and the like) containing program code therein. Computer usable storage media include permanent and non-permanent, removable and non-removable media, and may be implemented by any method or technique for storing information. The information may be computer-readable instructions, data structures, modules of a program, or other data. Examples of storage media for computers include, but are not limited to, phase-change memory (PRAM), static random access memory (SRAM), dynamic random access memory (DRAM), other types of random access memory (RAM), read-only memory (ROM), electrically erasable programmable read-only memory (EEPROM), flash memory or other memory technologies, read-only CD-ROM only Read-Only Memory (CD-ROM), Digital Versatile Disc (DVD) or other optical storage, magnetic cartridge tapes, magnetic tape disk storage or other magnetic storage devices, or any other non-transport media that can be used to store information that can be accessed by computing devices.

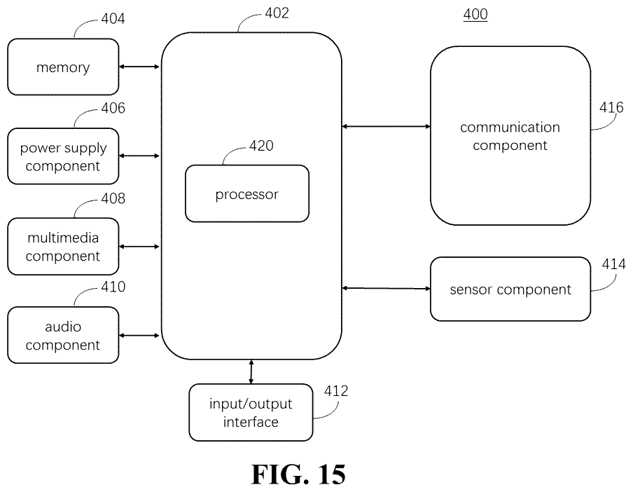

As shown in FIG. 15, FIG. 15 is a structural diagram of an electronic device according to an example of the present disclosure. The device 400 may be a smart phone or cell phone, a tablet computer, a personal digital assistant (PDA), a laptop computer, a desktop computer, a media player, a video game station or system, a virtual reality system, an augmented reality system, a wearable device such as a watch, eyeglasses, a glove, a headgear like a hat, a helmet, a virtual reality headset, an augmented reality headset, a head mounted device (HMD) or a headband, a pendant, an armband, a leg band, shoes, a vest, a remote control, or any other type of electronic device.

Referring to FIG. 15, the device 400 may include one or more of the following components: a processing component 402, a memory 404, a power supply component 406, a multimedia component 408, an audio component 410, an input/output (I/O) interface 412, a sensor component 414, and a communication component 416.

The processing component 402 generally controls the overall operation of the device 400, such as operations associated with displays, telephone calls, data communications, camera operations, and recording operations. The processing component 402 may include one or more processors 420 to execute instructions to accomplish some or all of the steps or procedures of the method described above. In addition, the processing component 402 may include one or more modules to facilitate interaction between the processing component 402 and other components. For example, the processing component 402 may include a multimedia module to facilitate interaction between the multimedia component 408 and the processing component 402.

The memory 404 is configured to store various types of data to support operations at the device 400. Examples of such data include instructions for any application or method operated on the device 400, contact data, phone book data, messages, pictures, videos, etc. The memory 404 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, a Disks or CD-ROMs.

The power supply component 406 provides power to various components of the device 400. The power supply component 406 may include a power management system, one or more power supplies, and/or other components associated with generating, managing, and distributing power for the device 400.

The multimedia component 408 includes a screen providing an output interface between the device 400 and users. In some implementations, the screen may include a liquid crystal display (LCD) and a touch panel (TP). If the screen includes a touch panel, the screen may be implemented as a touch screen to receive input signals from users. The touch panel includes one or more touch sensors to sense touches, swipes and gestures on the touch panel. The touch sensors may not only sense the boundaries of a touch or swipe action, but also detect the duration and pressure associated with the touch or swipe operation. In some implementations, the multimedia component 408 includes a front camera and/or a rear camera. The front camera and/or the rear camera may receive external multimedia data when the device 400 is in an operational mode, such as a shooting mode or a video mode. Each front camera and rear camera may be an optical lens system with a fixed focal length or an adjustable focal length and optical zoom capability.

The audio component 410 is configured to output and/or input audio signals. For example, the audio component 410 includes a microphone (MIC) that is configured to receive external audio signals when the device 400 is in an operational mode, such as a call mode, a recording mode, or a voice recognition mode. The received audio signals may be further stored in memory 404 or be sent via communication component 416. In some implementations, the audio component 410 further includes a speaker for outputting the audio signal.

The I/O interface 412 provides an interface between the processing component 402 and a peripheral interface module. The peripheral interface module may be keypads, click wheels, buttons, etc. The buttons may include, but are not limited to a home button, a volume button, a start button, or a lock button.

The sensor component 414 includes one or more sensors for providing status assessment of various aspects of the device 400. For example, the sensor component 414 may detect an on or off state of the device 400, the relative positioning of components, such as the relative positioning of the display and the keypad of the device 400. The sensor component 414 may detect a change in the position of the device 400 or in the position of one component of the device 400, presence or absence of user contact with the device 400, an orientation or acceleration/deceleration of the device 400, and temperature changes of the device 400. The sensor component 414 may include a proximity sensor configured to detect the presence of a nearby object without any physical contact. The sensor component 414 may include a light sensor, such as a CMOS or CCD image sensor, for use in imaging applications. In some implementations, the sensor component 414 may include an accelerometer sensor, a gyroscope sensor, a magnetic sensor, a pressure sensor, or a temperature sensor.

The communication component 416 is configured to facilitate wired or wireless communication between the device 400 and other devices. The device 400 may access a wireless network based on a communication standard such as WiFi, 2G, 4G, or 4G, or a combination thereof. In an example, the communication component 416 receives broadcast signals or broadcast-related information from an external broadcast management system via a broadcast channel. In an example, the communication component 416 further includes a near field communication (NFC) module to facilitate short range communication. For example, the NFC module may be implemented based on Radio Frequency Identification (RFID) technology, Infrared Data Association (IrDA) technology, Ultra Wide Band (UWB) technology, Bluetooth (BT) technology or other technologies.

In some examples, the device 400 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components for executing the above method.

In some examples, a non-transitory computer-readable storage medium including instructions is also provided, such as a memory 404 including instructions. The instructions are executable by the processor 420 of the device 400 for accomplishing the method. For example, the non-transitory computer readable storage medium may be a ROM, random access memory (RAM), CD-ROM, magnetic tape, floppy disk, optical data storage device, or the like.

After considering and practicing the present disclosure, those skilled in the art will readily conceive of other implementations. The present disclosure is intended to cover any variations, uses, or adaptations of the present disclosure that follow the general principles of the present disclosure and include means of common knowledge or customary techniques in the art not disclosed herein. The specification and implementations disclosed herein are to be regarded as examples.

It should be understood that, the present disclosure is not limited to the precise structure or procedure which has been described above and illustrated in the accompanying drawings, and various modifications and alterations may be made.

The foregoing is example implementation of the present disclosure, and is not intended to limit the present disclosure, and any modifications, equivalent substitutions, improvements, etc. may be made.

What is claimed is:

1. A method for displaying icons, comprising:
displaying, by an electronic device, a graphical user interface in a first view mode of a plurality of preset view modes, wherein the graphical user interface comprises a plurality of icons, and each of the plurality of preset view modes correspond to a different preset icon display size;
in response to detecting, by the electronic device, a zoom operation by a user, zooming and displaying at least a part of the plurality of icons according to the zoom operation while the zoom operation continues;
in response to detecting completion of the zoom operation, determining, by the electronic device, a target view mode from the plurality of preset view modes; and
displaying at least a part of the plurality of icons with a preset icon display size corresponding to the target view mode.

2. The method of claim 1, wherein determining the target view mode from the plurality of preset view modes comprises:
determining the target view mode from the plurality of preset view modes based on at least one of the following: a zoom ratio or an icon display size instructed at the end of the zoom operation, a current view mode for displaying the graphical user interface at the end of the zoom operation, the first view mode, or a zoom ratio or a preset icon display size corresponding to each of the plurality of preset view modes.

3. The method of claim 1, wherein determining the target view mode from the plurality of preset view modes comprises:
in response to a current view mode for displaying the graphical user interface at the end of the zoom operation being a maximum view mode corresponding to a largest preset view display size among the plurality of preset view mode, and to the icon display size instructed at the end of the zoom operation being larger than the largest preset icon display size, determining the maximum view mode as the target view mode; or
in response to the current view mode for displaying the graphical user interface at the end of the zoom operation being a minimum view mode corresponding to a smallest preset view display size among the plurality of preset view modes, and to the icon display size instructed at the end of the zoom operation being smaller than the smallest preset icon display size, determining the minimum view mode as the target view mode.

4. The method of claim 1, wherein zooming and displaying at least a part of the plurality of icons according to the zoom operation while the zoom operation continues, further comprises:
zooming and displaying at least a part of the plurality of icons in the first view mode according to a zoom ratio or an icon display size currently instructed by the zoom operation; or
switching the graphical user interface from the first view mode to a second view mode based on the zoom ratio or the icon display size currently instructed by the zoom operation.

5. The method of claim 1, wherein zooming and displaying at least a part of the plurality of icons according to the zoom operation while the zoom operation continues, further comprises:
in response to an icon display size currently instructed by the zoom operation being between a preset icon display size corresponding to the first view mode and a preset icon display size corresponding to a second view mode, displaying at least a part of the plurality of icons according to the icon display size currently instructed by the zoom operation as well as a preset icon display size corresponding to the first view mode; or
in response to an icon display size currently instructed by the zoom operation reaching the preset icon display size corresponding to the second view mode, displaying at least a part of the plurality of icons with a preset icon display size corresponding to the second view mode.

6. The method of claim 1, wherein zooming and displaying at least a part of the plurality of icons according to the zoom operation while the zoom operation is still ongoing, further comprises:
in response to the graphical user interface being currently displayed in a maximum view mode corresponding to a largest preset view display size among the plurality of preset view modes, and to the zoom operation instructing to continue to zoom in, zoom in and displaying at least a part of the plurality of icons in accordance with a zoom ratio currently instructed by the zoom operation and a zoom-in ratio threshold, or in accordance with an icon display size currently instructed by the zoom operation and a maximum icon display size; or
in response to the graphical user interface being currently displayed in a minimum view mode corresponding to a smallest preset view display size among the plurality of preset view modes, and to the zoom operation instructing to continue to zoom out, zooming out and displaying at least a part of the plurality of icons in accordance with a zoom ratio currently instructed by the zoom operation and a zoom-out ratio threshold, or in accordance with an icon display size currently instructed by the zoom operation and a minimum icon display size.

7. The method of claim 1, wherein the plurality of preset view modes comprise at least one of a maximum view mode, an intermediate view mode, or a minimum view mode;
the graphical user interface displayed in the maximum view mode comprises one icon located at a first position and icon description text located at a second position near the first position;
the graphical user interface displayed in the minimum view mode comprises at least two center icons displayed with a first size and at least two peripheral icons displayed with a second size surrounding the at least two center icons, the first size being larger than the second size; and
the graphical user interface displayed in the intermediate view mode comprises a plurality of icons displayed with a same size.

8. The method of claim 1, wherein zooming and displaying at least a part of the plurality of icons according to the zoom operation while the zoom operation is still ongoing, comprises:
in response to switching to a second view mode, displaying at least a part of the plurality of icons with a predetermined icon display size corresponding to the second view mode, and then zooming and displaying at least a portion of the plurality of icons proportionally according to a zoom ratio currently indicated by the zoom operation.

9. The method of claim 1, further comprising:
detecting, by the electronic device, an icon moving operation of the user;
in response to an overlap between a target area of the plurality of icons instructed by the icon moving operation and a display area of the electronic device being less than a first threshold, moving at least two edge icons of the plurality of icons into the display area of the electronic device for display.

10. A method for icon display, comprising:
displaying a graphical user interface, wherein the graphical user interface comprises a plurality of icons arranged in columns;
receiving an icon management instruction from a user, wherein the icon management instruction instructs to manage a position of a first icon occupying a first position, and the first position is located in a first column;
removing the first icon from the first position according to the icon management instruction;
determining at least one first shift icon in the first column, wherein the at least one first shift icon occupies at least one adjacent position in the first column; and
moving each of the at least one first shift icon by one or more positions along a direction toward the first position.

11. The method of claim 10, wherein
the icon management instruction instructs to move the first icon to a second position in a second column other than the first column, or the icon management instruction instructs to delete the first icon; and
the at least one first shift icon occupies at least one adjacent position from a position adjacent to the first position to a first edge position of the first column.

12. The method of claim 10, wherein
the icon management instruction instructs to move the first icon to a second position in a second column other than the first column, or the icon management instruction instructs to delete the first icon; and
the method further comprises:
determining at least one second shift icon occupying at least one position in a same column other than the first column; and
moving each of the at least one second shift icon by one or more positions, such that one of the at least one second shift icon is moved to a first edge position of the first column.

13. The method of claim 10, wherein
the icon management instruction instructs to move the first icon to a second position in a second column other than the first column; and
the method further comprises:
determining at least one second shift icon occupying at least one adjacent position of the second column from the second position to a second edge position; and
moving the at least one second shift icon, such that an icon occupying the second edge position is moved to a first edge position of the first column.

14. The method of claim 13, wherein moving the at least one second shift icon, comprises:
moving at least one of the at least one second shift icon by one or more positions along a direction away from the second position.

15. The method of claim 10, wherein the icon management instruction instructs to move the first icon to a second position in the first column; and
the at least one first shift icon occupies at least one adjacent position from a position adjacent to the first position to the second position.

16. The method of claim 10, wherein
the icon management instruction instructs to delete the first icon; and
the method further comprises: moving an icon with a largest number among the plurality of icons to a first edge position of the first column.

17. The method of claim 10, wherein
the plurality of icons comprise a plurality of center icons displayed with a first size and a plurality of surrounding icons displayed with a second size, the first size being larger than the second size, the plurality of surrounding icons being arranged around the plurality of center icons; or
the plurality of icons are arranged in a configuration including a plurality of rings surrounding one another, each ring including at least two icons located in at least two columns.

18. An electronic device, comprising:
a processor; and
a memory storing executable instructions, which when executed by the processor, the method of claim 1 is implemented.

19. A non-transitory computer-readable storage medium storing one or more computer programs, which when executed by a processor, the method of claim 1 is implemented.

20. A non-transitory computer-readable storage medium storing one or more computer programs, which when executed by a processor, the method of claim 10 is implemented.
